(19) United States
(12) Patent Application Publication
(10) Pub. No.: US 2004/0058818 A1
(43) Pub. Date: Mar. 25, 2004

(54) System for increasing the production of camptothecin from plants

(76) Inventor: Shiyou Li, Nacogdoches, TX (US)

Correspondence Address: Alan R. Thiele, JENKENS & GILCHRIST, 3200 Fountain Place, 1445 Ross Avenue, Dallas, TX, 75202-2799, US

(21) Appl. No.: 10/670,930

(22) Filed: Sep. 25, 2003

Related U.S. Application Data
(63) Continuation of application No. 09/696,042, filed on Oct. 25, 2000.
(60) Provisional application No. 60/161,460, filed on Oct. 25, 1999.

(51) Int. Cl. A01N 25/00; A01B 79/02

(52) U.S. Cl. 504/116.1; 47/58.1 R

(57) ABSTRACT

The present invention provides a system for increasing the production of indole and quinoline alkaloids, particularly camptothecins and related compounds, in plants, based upon management of plant hormones. This invention includes a system and a method for accelerating the growth of young tissues, inducing the production of camptothecins-bearing glandular trichomes, maximizing the harvest of glandular trichomes, and preserving and treating the glandular trichomes for maximum camptothecins yield. The present invention is useful for any plant matters containing alkaloids, regardless of the plant matters' genetic origin, natural or cultivated variety, and natural or cultivated growing conditions.

### REFERENCE TO RELATED APPLICATION

This application claims priority from U.S. Provisional Patent Application Serial No. 60/161,460 filed (unknown date) and is a continuation patent application based on U.S. patent application Ser. No. 09/696,042 filed Oct. 25, 2000.

### BACKGROUND OF THE INVENTION

1. Field

The present invention relates to a process for increasing the amount of indole and quinoline alkaloids, particularly camptothecins and related compounds harvested from plants; more specifically, the present invention is described in terms of harvesting increased amounts of alkaloids from plants by increasing the growth of young tissues having high concentrations of the alkaloids and by the use of trichome management techniques based on interaction principles of hormones and alkaloids in plants.

2. Background

The plant-produced alkaloid camptothecin (CPT) is presently becoming widely used in anti-cancer medications. Specifically, camptothecin is used in production of Topotecan (TPT, Hycamtin®) for the treatment of advanced ovarian cancer and small cell lung cancer, Irinotecan (CPT-11, Camptosar®) for the treatment of colon cancer, and 9-Nitrocamptothecin (9-NC, Rubitecan®) for the treatment of pancreatic cancer. It has been reported that additional drug studies are presently underway to expand the use of this important plant alkaloid into still other anti-cancer drugs.

A diagram of the chemical structure of natural camptothecin and its analogs appears in FIG. 1.

Since the initial identification of camptothecin, at least 11 different naturally occurring camptothecin analogs have been identified from wood, bark, and fruits of Camptotheca acuminata plants. Specifically, 10-hydroxycamptothecin is found in wood and in fruits, 10-methoxycamptothecin is also found in wood, 11-hydroxycamptothecin is found in fruits, 11-methoxycamptothecin is also found in fruits, 20-deoxycamptothecin is found in bark, 20-hexanolycamptothecin is also found in bark and 20-hexanoyl-10-methoxycamptothecin is found in bark, 22-hydroxyacuminatine is found in fruits, 19-hydroxymappicine is found in fruits, and 19-O-methylangustoline is also found in fruits.

Many plant species which are known to produce camptothecins (the term camptothecins is used to describe camptothecin and its analogs). The plants which are known to produce camptothecins are:

A. Camptotheca (Nyssaceae); including: Camototheca acuminata Decaisne, Camptotheca acuminata var. tenuifolia Fang et Song, Camptotheca acuminata var. rotundifolia Yang et Duan, Camptotheca vunnanensis Dode, Camiptotheca lowreyana Li, Camptotheca lowreyana Li ‘Katie’;

B. Ervatamia (Apocynaceae);

C. Nothapodvtes (Mappia) (Olacaceae);

D. Ophiorrhiza (Rubiaceae);

E. Merrilliodendron (Icacinaceae);

F. Mostuea (Loganiaceae);

G. Pvrenacantha (Icacinaceae).

Camptothecin is commonly obtained from the fruit of the Xi Shu tree which grows primarily in China because it is widely believed that the fruit of the Xi Shu tree contains the highest levels of camptothecin. The Xi Shu tree (Camptotheca acuminata) is a species of the genus Camptotheca, which is a Chinese endemic genus of the family Comaceae (or Nyssaceae). The Xi Shu trees are processed and then chemical solvents are used to obtain small amounts of camptothecin from large quantities of the processed bark, fruit, leaves, and stems. Accordingly, the cost of pharmaceutical grade camptothecin is quite high. This high price escalates the cost of camptothecin-based medications. So far, there has been no success in synthesizing camptothecin at commercially acceptable levels. Additionally, it has been found that cell cultures have not been able to produce a consistently higher yield of camptothecin than has been obtained from trees of Camptotheca acuminata.

Further complicating the problem is the fact that the Chinese government has declared Camptotheca acuminata as an endangered species and accordingly has limited the harvest of these plants growing in the wild.

Therefore, a need has developed in the art to develop a system for increasing the production of camptothecin in plants to meet the growing demand for camptothecin for use in cancer-fighting medications.

### SUMMARY

The present invention provides a system for increasing the production of the plant-produced alkaloid camptothecins in those species of plants which produce camptothecins according to interaction principles of hormones and alkaloids. Specifically, the system of the present invention is directed to:

(1) Accelerating the growth of young vegetative tissues, particularly leaves and stems;

(2) Inducing the production of camptothecins-bearing glandular trichomes on young vegetative tissues, particularly leaves and stems, by the application of trichome management techniques including T-pruning, simulated herbivory or leaf tip pinching and the imposition of environmental stress factors on the plants;

(3) Maximizing the amount of camptothecins-bearing glandular trichomes obtained from the plants by harvesting intact clippings of young vegetative tissues at predetermined times;

(4) Preserving the camptothecins-bearing trichomes on the harvested young vegetative tissues to maximize the amount of camptothecins-bearing glandular trichomes remaining with the young vegetative tissues;

(5) Treating the young vegetative tissues with either an ultrasonic processor, a homogenizer, or other mechanical device to break the walls of the glandular trichomes to release the camptothecins contained therein.

My invention is useful for any plant matters containing alkaloids, including indole and quinoline alkaloids, particularly camptothecins. These plant matters may be of pure genetic origin, mixed genetic or hybrid origin, or unknown genetic origin. Plant matters may be harvested from plants of either natural species and varieties or cultivated varieties (cultivars) growing in both the natural and cultivated conditions.

Accordingly, it is an object of the present invention to induce the production of camptothecins-bearing glandular trichomes and to preserve and extract the camptothecins from plants.

It is also an object of the present invention to induce the production of camptothecins by managing the production of the plant hormones which affect the production of camptothecins by the plant.

It is also an object of the present invention to accelerate the growth of young vegetative tissues, specifically leaves and stems, and to further induce the production by the plant of camptothecins-bearing glandular trichomes on the accelerated growth vegetative tissues. It is still a further object of the present invention to provide a method for the harvesting and the preservation of young vegetative tissues so that the loss of camptothecins-bearing trichomes is minimized.

It is yet another object of this invention to provide a method for the effective extraction of camptothecins from camptothecins-bearing glandular trichomes by breaking the trichome walls.

### BRIEF DESCRIPTION OF THE DRAWING FIGURES

A more complete understanding of the objects and processes of the present invention may be had by reference to the following detailed description taken in conjunction with the accompanying drawings, wherein:

FIG. 1 is a set of diagrams of the chemical structures of natural camptothecin and its analogs in Camptotheca acuminata: camptothecin (1), 10-hydroxycamptothecin (2), 10-methoxycamptothecin (3), 11-hydroxycamptothecin (4), 11-methoxycamptothecin (5), 20-deoxycamptothecin (6), 20-hexanoylcamptothecin (7), 20-hexanoyl-10-methoxycamptothecin (8), 22-hydroxyacuminatine (9), 19-hydroxymappicine (10), 19-O-methylangustoline (11), and vincoside-lactam (12);

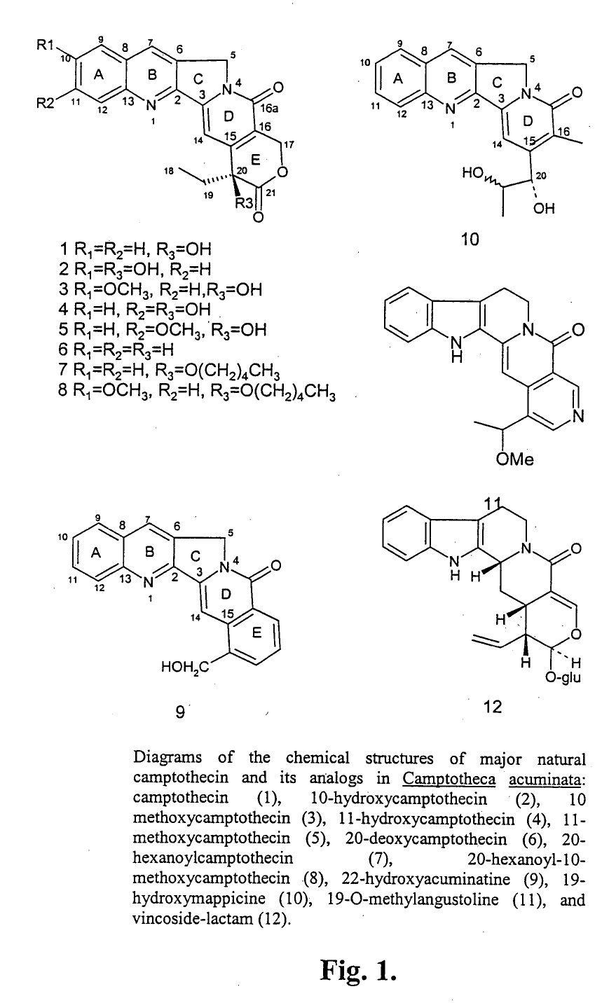

FIG. 2 is a table listing CPT distribution in different tissues of Camptotheca acuminata;

FIG. 3 is a scanning electron micrograph of Camptotheca lowreyana ‘Katie’: a. the surface view of lower leaf epidermis, b. a mature glandular trichome (GT) on the lower leaf surface;

FIG. 4 is a table stating the glandular trichome size and density on lower leaf surfaces and CPT concentrations in leaves of Camptotheca;

FIG. 5 is a diagram of two biosynthetic pathways showing tryptophan (Trp) as a biosynthetic precursor for both indoleacetic acid (Route A for stimulating growth) and camptothecin (Route B for inhibiting growth);

FIG. 6 is a photograph of Camptotheca lowreyana ‘Katie’;

FIG. 7 is a drawing of a Camptotheca leaf after leaf-tip pinching;

FIG. 8 is a drawing of Camptotheca seedling T-pruning treatments and control;

FIG. 9 is a drawing of the leaf-tip pinching technique as applied in Camptotheca;

FIG. 10 is a picture of HPLC profiles showing the induction of CPT and its analogs in Camptotheca acuminata by pinching (a: control, b: with pinching treatment);

FIG. 11 is a scanning electron micrograph of a glandular trichome on upper leaf surface of Camptotheca acuminata (A: before treatment; B: after treatment);

FIG. 12 is a table stating the mean height growth of plants with different T-pruning treatments;

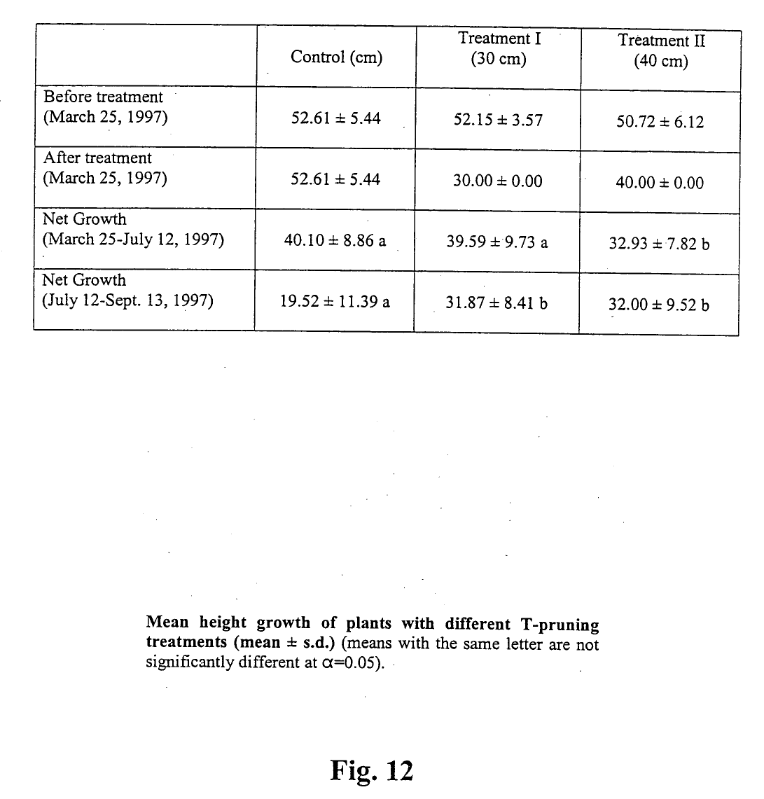

FIG. 13 is a table listing the mean branch number of plants with different T-pruning treatments;

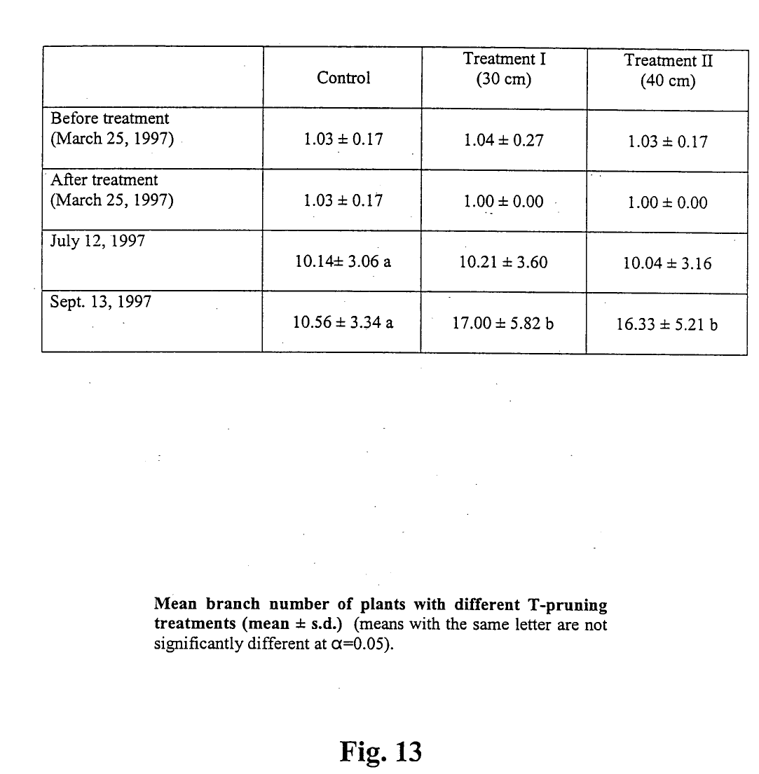

FIG. 14 is a graph of the monthly biomass production of intact young tissues with and without T-pruning;

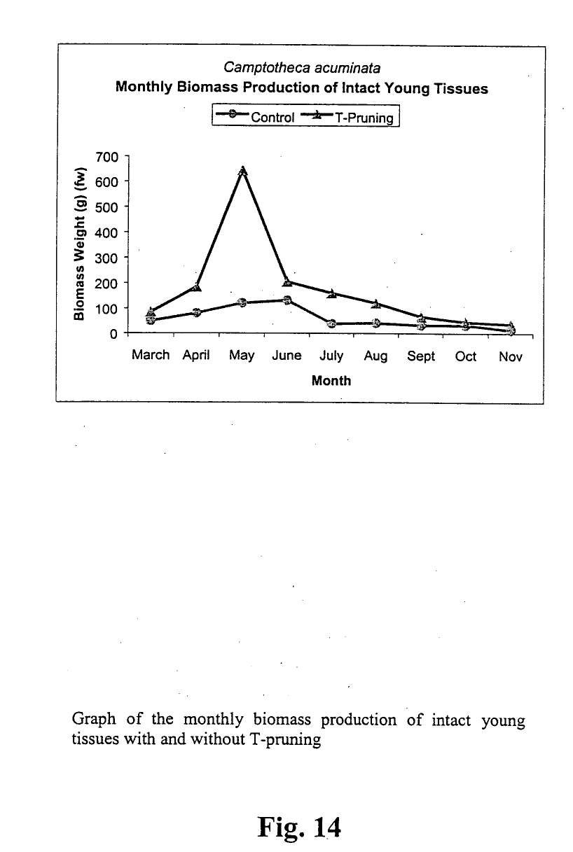

FIG. 15 is a table noting the effects of T-pruning treatments on CPT contents of intact young tissues of Camiptotheca acuminata;

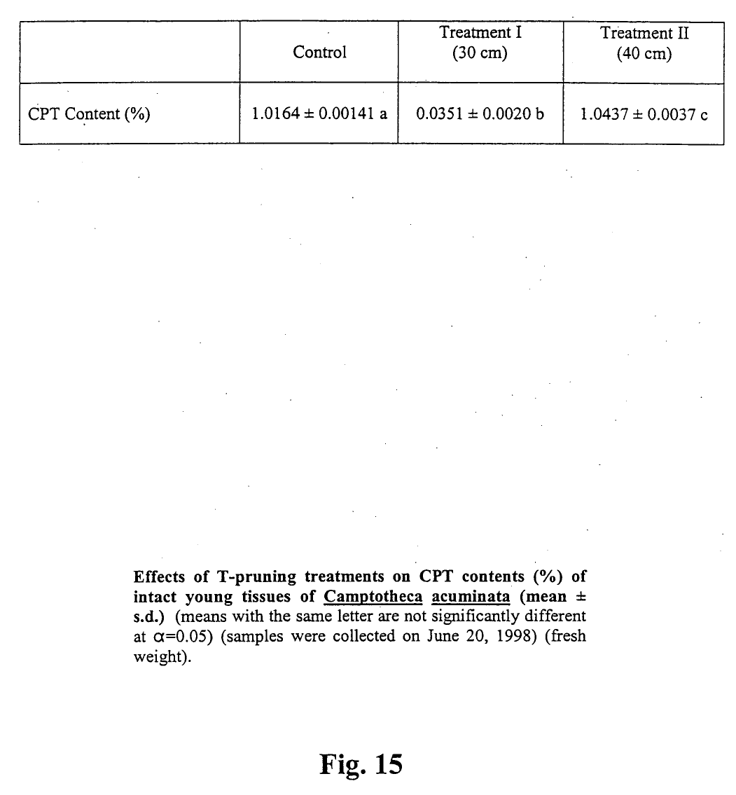

FIG. 16a is a graph of the effect of pinching on CPT concentration in the whole plant of Camptotheca acuminata;

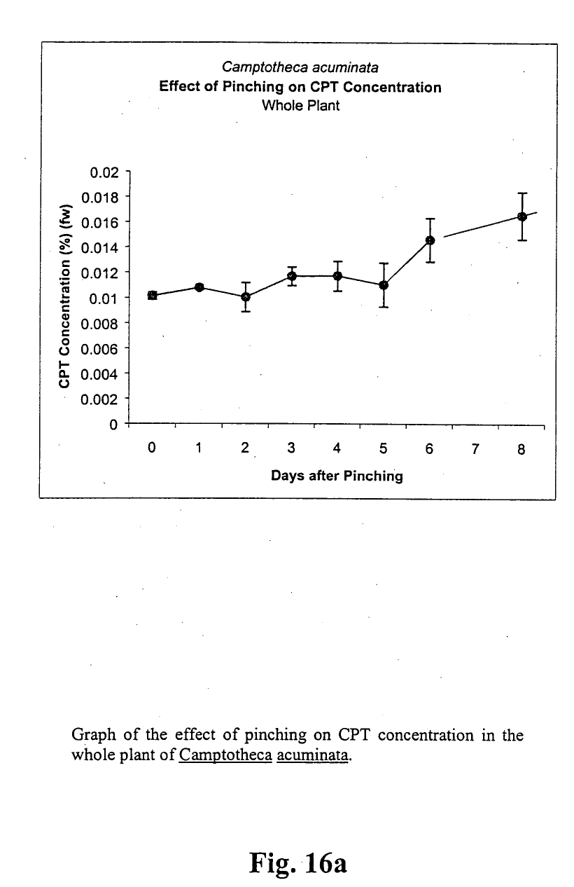

FIG. 16b is a graph of the effect of pinching on CPT concentration in intact young tissues of Camptotheca acuminata;

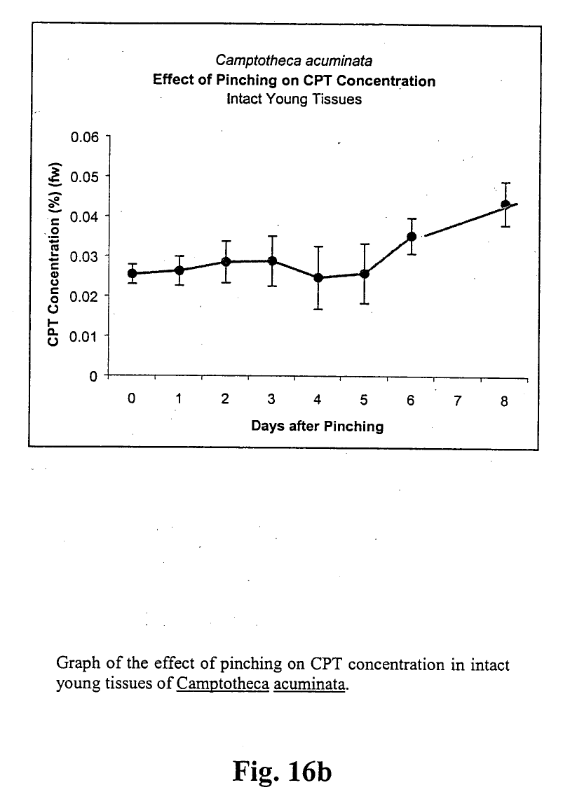

FIG. 16c is a graph of the effect of pinching on CPT yield on the whole plant in Camptotheca acuminata;

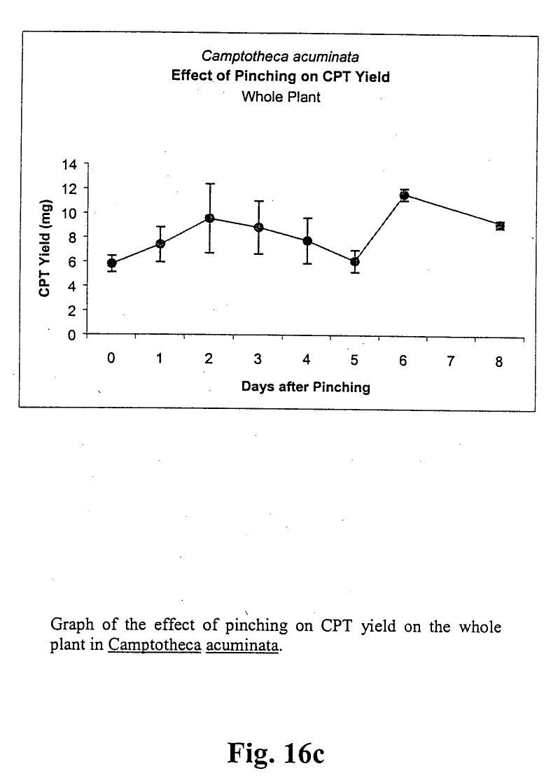

FIG. 16d is a graph of the effect of pinching on CPT yield on intact young tissues in Camptotheca acuminata;

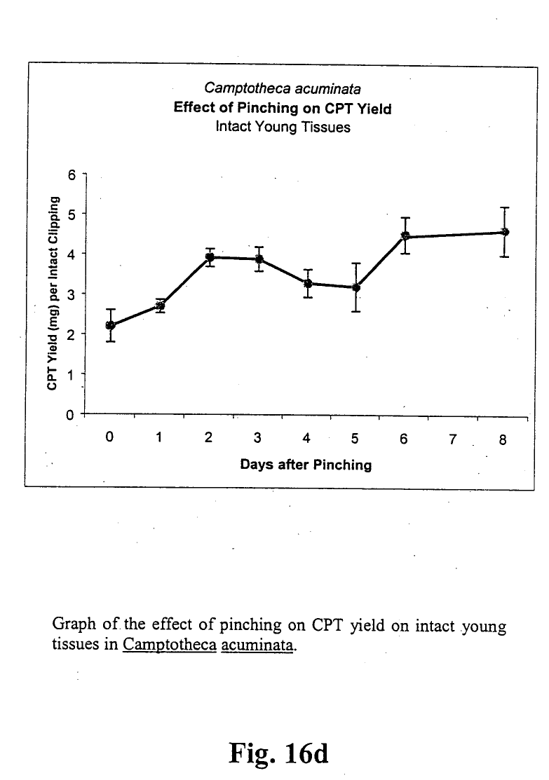

FIG. 17a is a graph of CPT induction by pinching in young leaves and relatively young leaves of Camptotheca acuminata;

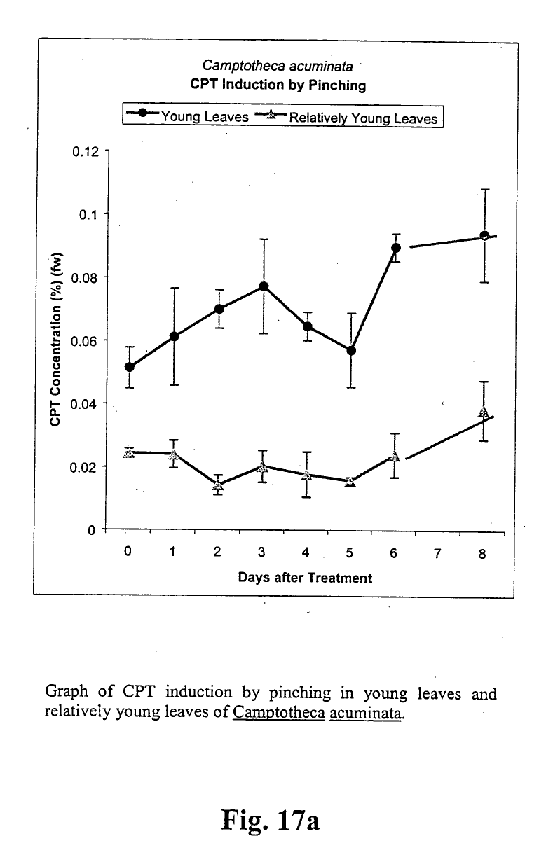

FIG. 17b is a graph of CPT induction by pinching in old leaves of Camptotheca acuminata;

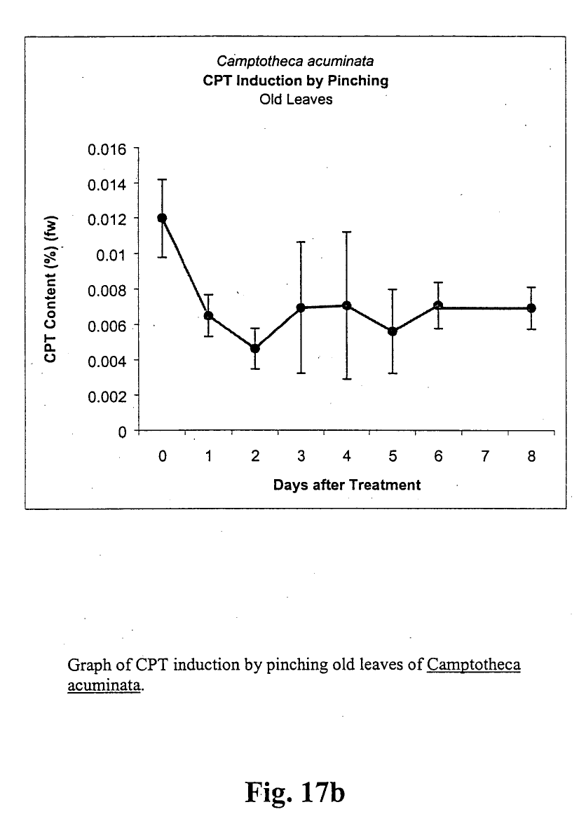

FIG. 17c is a graph of CPT induction by pinching in young stems and old stems in Camptotheca acuminata;

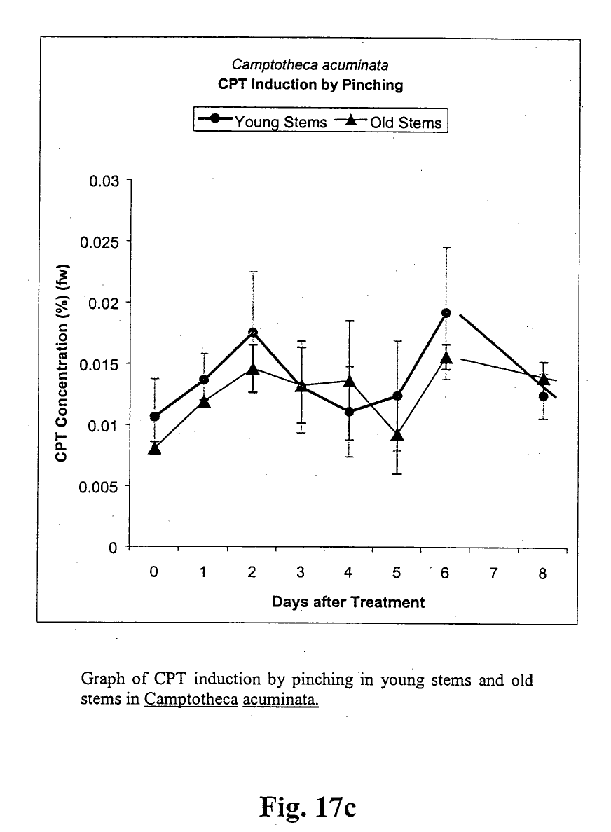

FIG. 17d is a graph of CPT induction by pinching in young roots and old roots in Camptotheca acuminata;

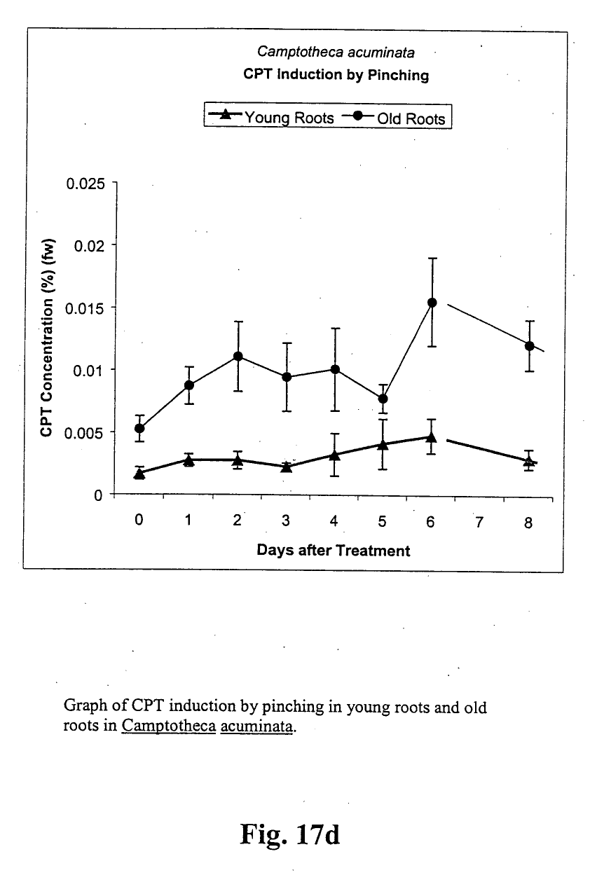

FIG. 18 is a table of the effects of pinching treatments on CPT contents of intact young tissues of Camptotheca acuminata under irrigation system;

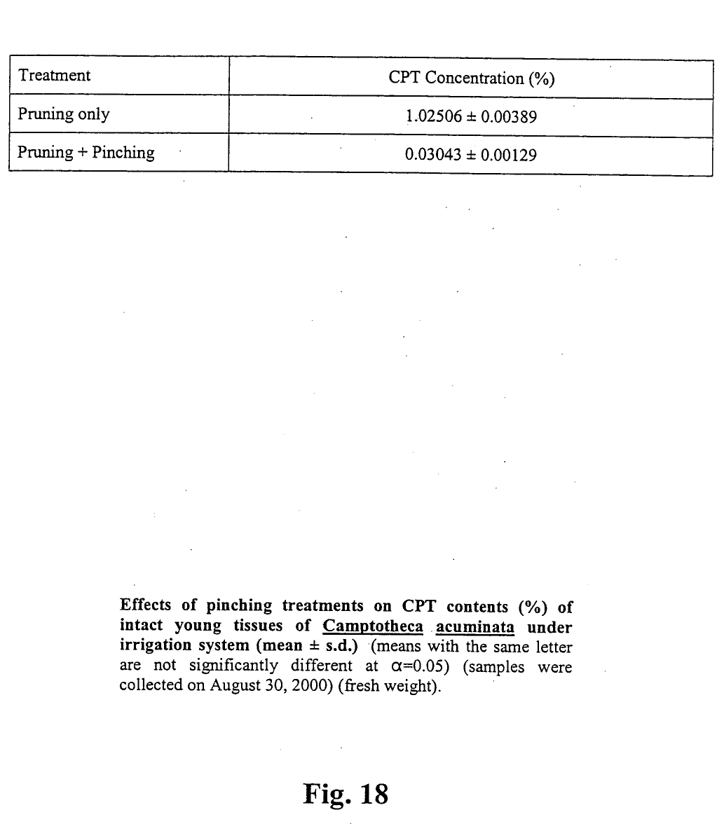

FIG. 19 is a table of the mean growth of one-year-old seedlings grown under different light levels;

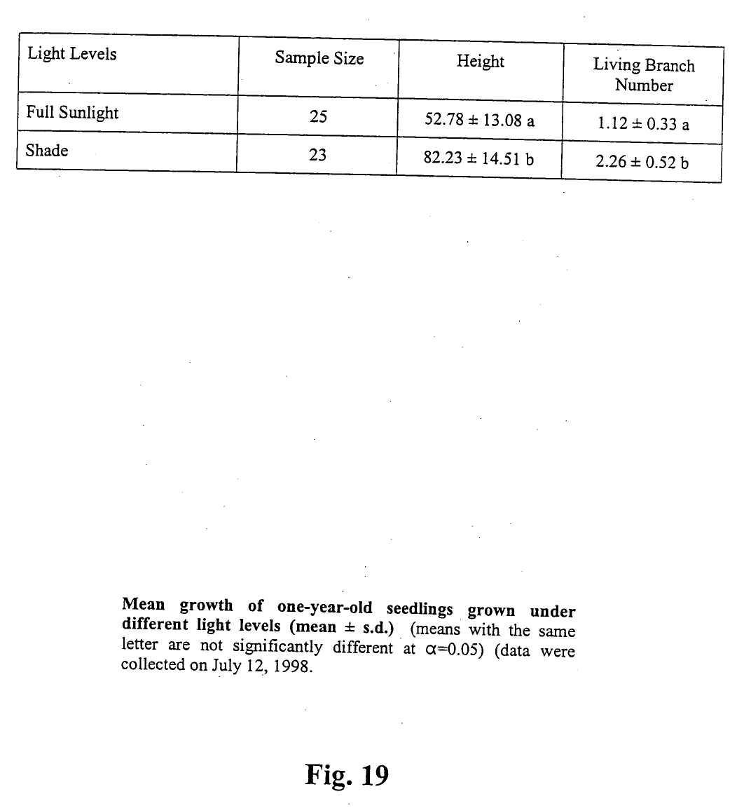

FIG. 20 is a table of the mean growth and glandular trichome density of three-year-old seedlings grown under different light levels;

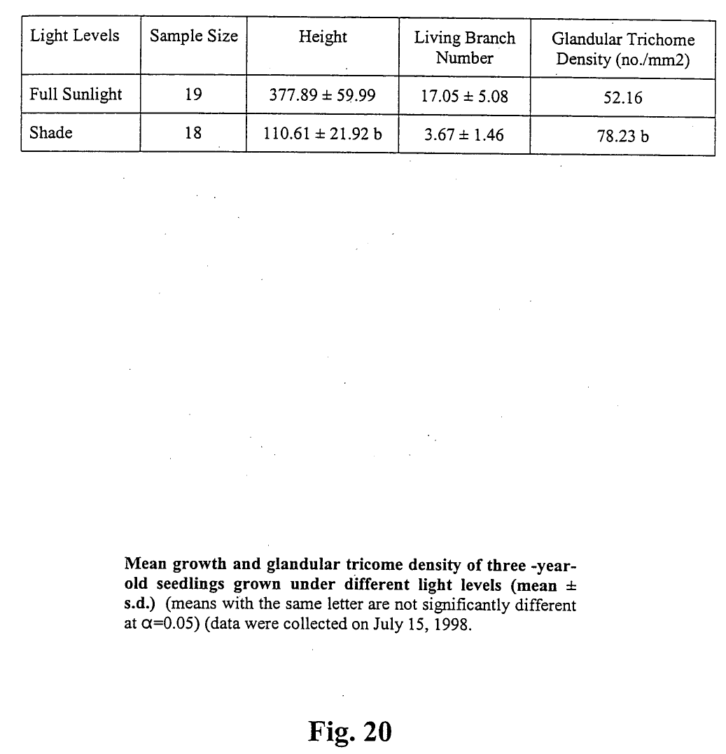

FIG. 21 is a table of the production of biomass and CPT of intact young tissues under different water conditions;

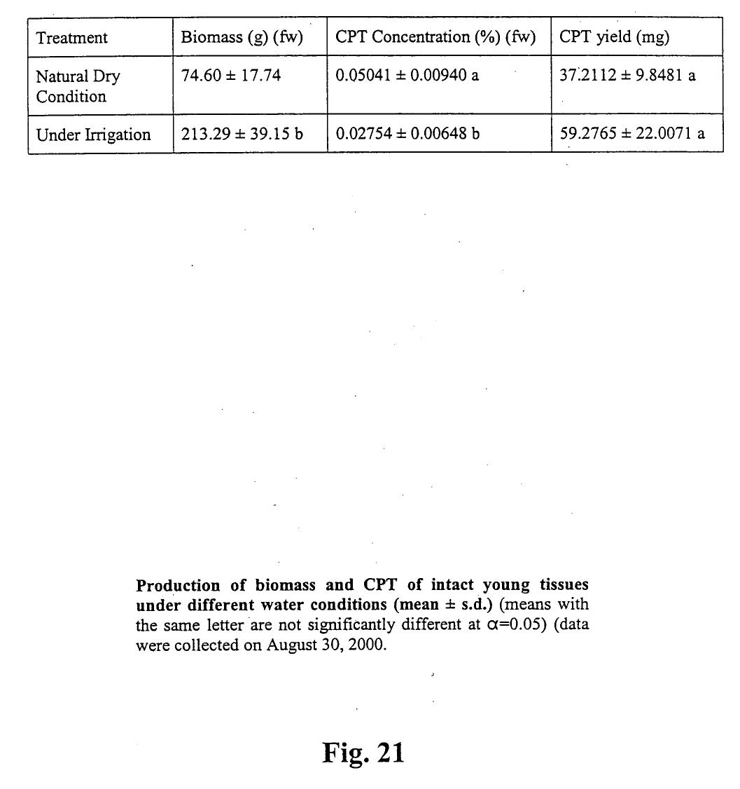

FIG. 22 is a table of the distribution pattern of biomass, CPT content, and CPT yield in an intact clipping of Camptotheca acuminata;

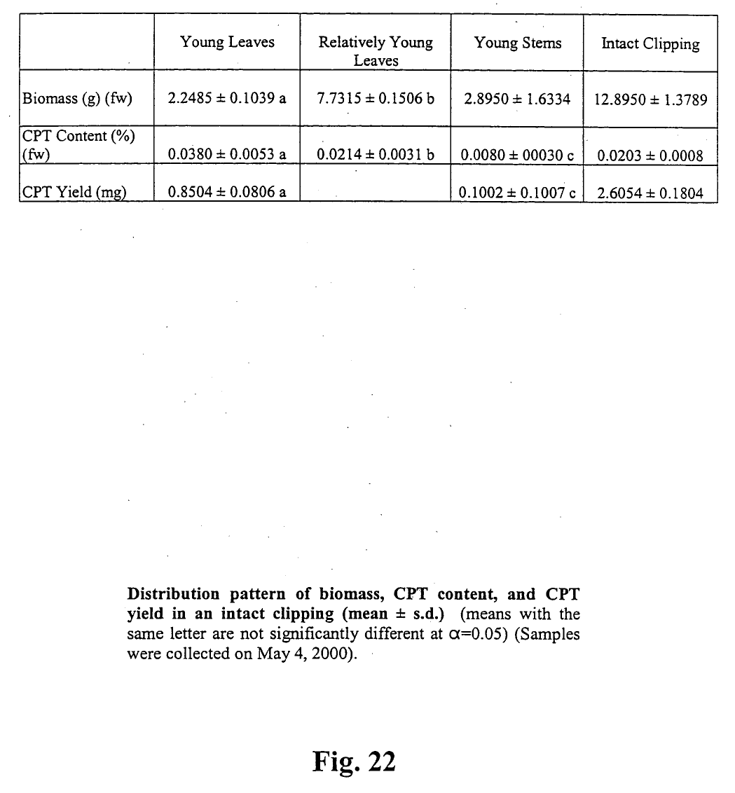

FIG. 23 is a drawing showing the distribution of biomass and CPT yield in an intact clipping (intact young tissue) in Camptotheca acuminata;

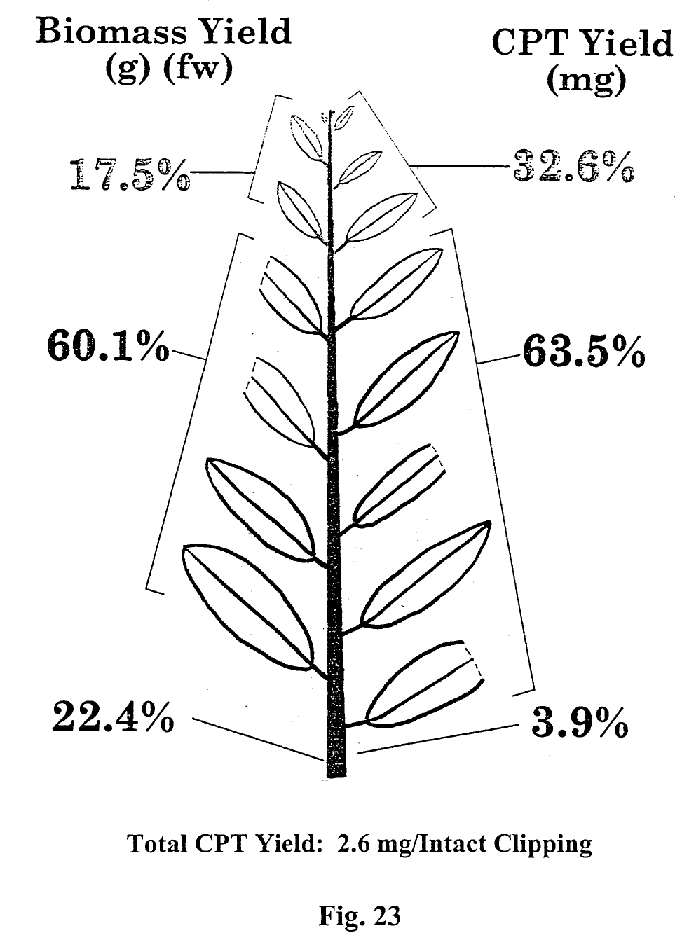

FIG. 24a is a graph of the effect of harvest cycle on CPT content of intact young tissues in Camptotheca acuminata;

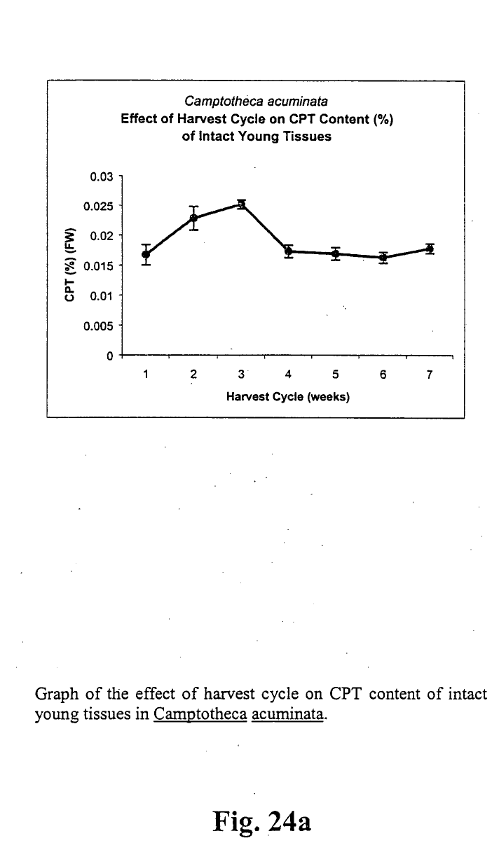

FIG. 24b is a graph of the effect of harvest cycle on CPT yield of intact young tissues in Camptotheca acuminata;

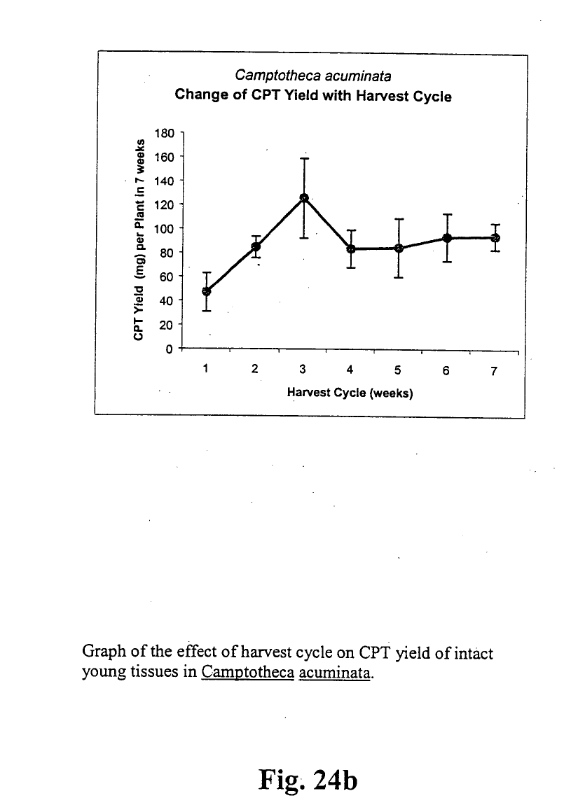

FIG. 25 is a graph of the variation in CPT concentration of young leaves with tree age in Camptotheca acuminata;

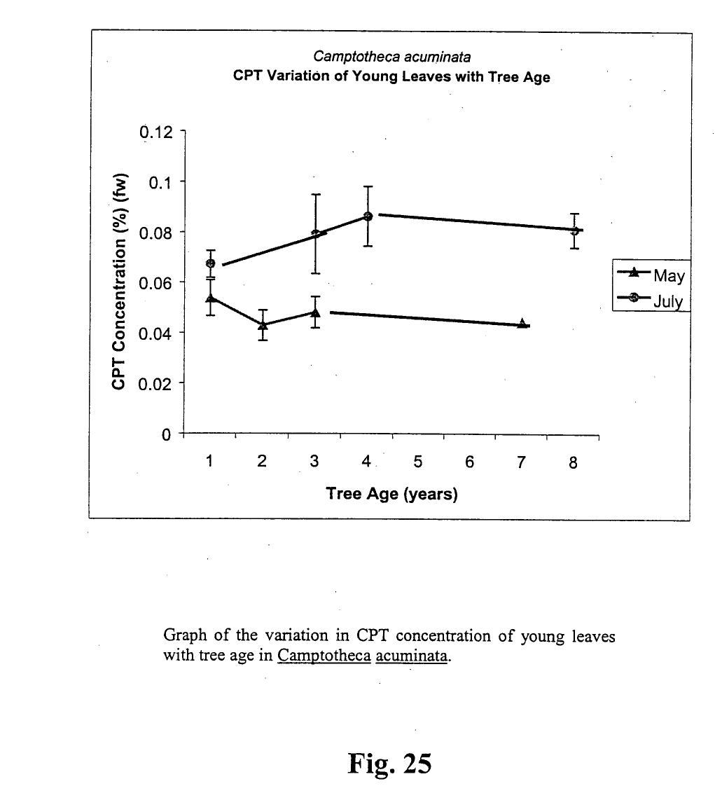

FIG. 26a is a graph of the monthly change of CPT content of intact young tissues of Camptotheca acuminata;

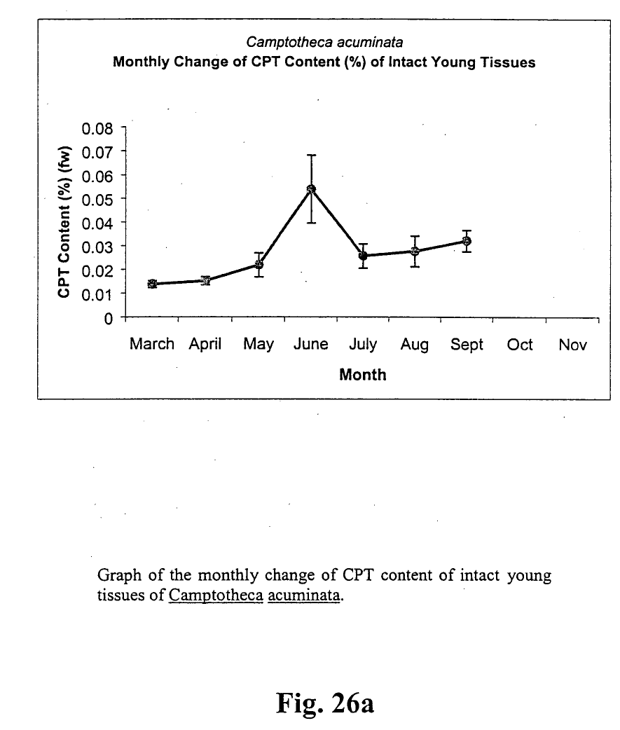

FIG. 26b is a graph of the monthly yield of CPT of intact young tissues of Camptotheca acuminata;

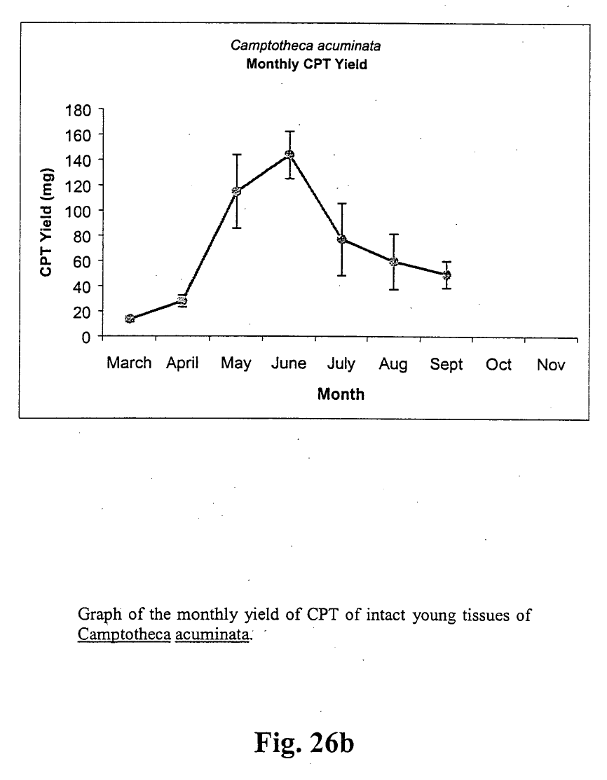

FIG. 27 is a table of the CPT preservation in intact young tissues preserved by different methods;

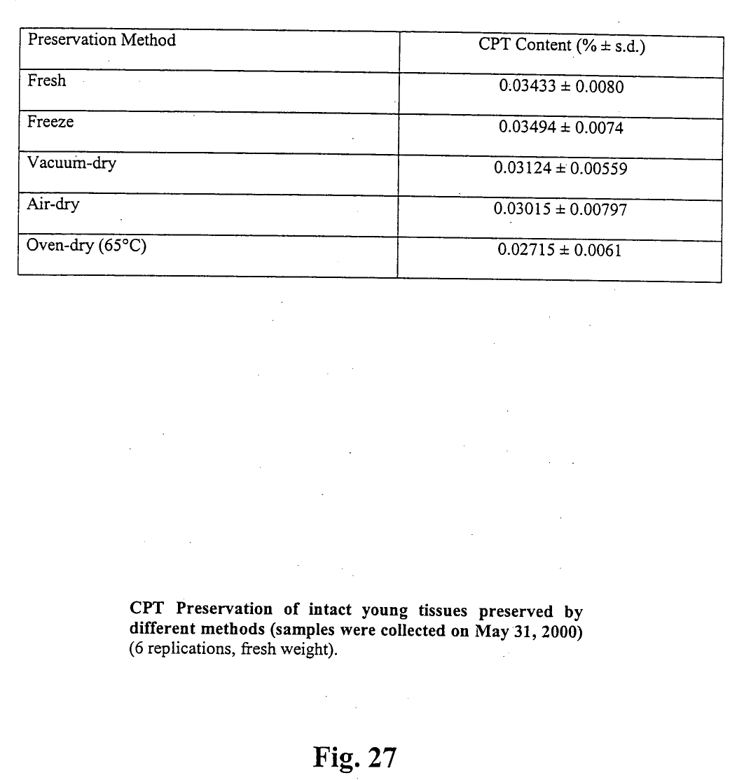

FIG. 28a is a graph of the effect of homogenizer treatment on CPT extraction in Camptotheca acuminata by duration of treatment time; and

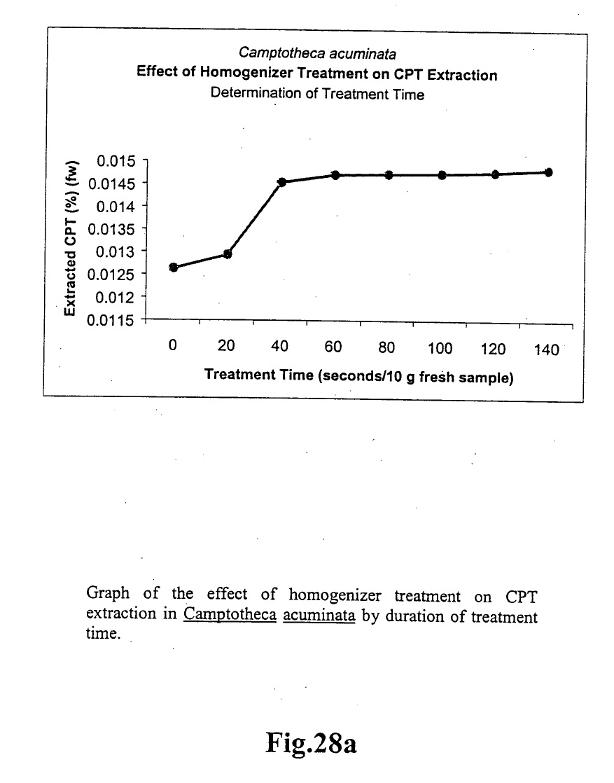

FIG. 28b is a graph of the effect of homogenizer treatment on CPT extraction in Camptotheca acuminata by extraction efficacy.

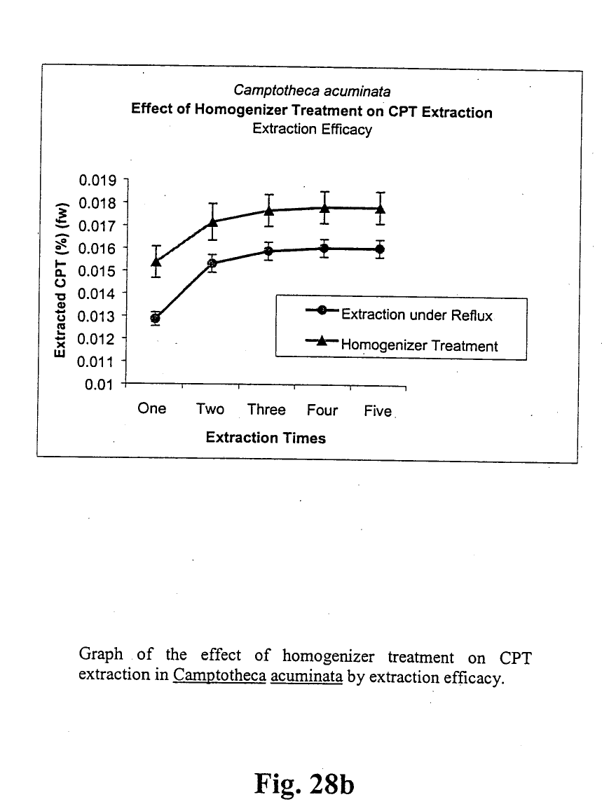

### DESCRIPTION OF THE EMBODIMENTS

A better understanding of the discoveries which led to the creation of the disclosed system for increasing the production of camptothecins from plants may be obtained from an understanding of the research and development history of the disclosed invention.

Historical Background

The discovery which led to the use of the alkaloid camptothecin as the basis for anti-cancer drugs may be traced back to reports that the leaves of the Camptotheca acuminata tree had anti-cancer activity. However, early research on the presence of camptothecin in Camptotheca acuminata produced inconclusive results. Specifically, some researchers were unable to detect camptothecin in the leaves, while others believe that more camptothecin was contained in the leaves of the plant than in either the roots or the stems. What was known is that the leaves of the Camptotheca acuminata plants were toxic and that goats who ate the leaves of the plants repeatedly died.

I found still further evidence concerning the location of camptothecin in Camptotheca acuminata from the fact that the Chinese Tung people in Guangdong province had been using the extract of young leaves of trees of Camptotheca (genus) with alcohol as a treatment for stubborn skin diseases, including cancers, for many years.

An initial investigation into the yield of the alkaloid camptothecin by Camptotheca acuminata revealed contradictory results in the literature. Specifically, studies have shown that almost all parts of the plants in Camptotheca acuminata would yield the alkaloid camptothecin with concentrations ranging from 0.004% to 0.400% per dry weight of vegetative biomass. Other studies indicated that the content of the alkaloid camptothecin in different parts of Camptotheca acuminata occur at an average rate of 5:10:5:2:15 for roots: root bark: stem bark: stems: and fruits, respectively. Accordingly, many believe that the fruit includes the highest level of camptothecin.

In an effort to better determine the location of the camptothecins in Camptotheca acuminata, some researchers found that the amount of camptothecin contained in the young leaves was approximately 50% higher than the amount of camptothecin found in the fruit of the plant and as much as 250% higher than the amount of camptothecin found in the bark. It is now widely accepted by those who study Camptotheca acuminata that the young leaves of the plant produce more camptothecin than the older leaves. However, it has never been clearly understood exactly in which cells and by what pathways camptothecins are accumulated in the plants.

As previously indicated, camptothecin is an alkaloid. An alkaloid is a secondary metabolite which is produced by plants. For many years it was believed that secondary metabolites had little explicit function in plants. However, recent research has indicated that secondary metabolites play a significant physiological and ecological role in plants. It is known that in some plants, particularly higher plants, the plant produces glandular trichomes which, in addition to other parts of the plants, contain secondary metabolites, specifically alkaloids, to defend against insect herbivory and attacks on the plant by microbes.

My research to determine the accumulation sites of the camptothecins in the leaves of plants in Camptotheca acuminata began with an analysis of young leaves. This analysis led to the discovery that the young leaves of Camptotheca acuminata contained a three to five times higher concentration of camptothecin than existed in older leaves. This discovery was consistent with the well known finding that some alkaloid-containing plant species have higher alkaloid levels in young leaves than in older leaves. It was still unknown at this point in the research exactly where the camptothecin was contained in the leaf.

The economic significance of trichome response and the chemical defense response of plant mechanical or environmental stresses have remained unexplored. Plant growth management strategies to investigate the maximization of the stimulation of chemical production in medicinal plants have not been developed. Accordingly, to determine how to cause plants in the Camptotheca genus to produce more camptothecins, it was necessary to discover those strategies which stimulated the production of camptothecin in plant trichomes.

On the Timing of the Presence of Camptothecins in Plant Life

To further understand the biosynthesis of the camptothecins in the leaves, it was also necessary to add a time component to the description of a leaf. Specifically, it was necessary to define young leaves as leaves that were newly spread, specifically, young leaves that were mostly less than one week old.

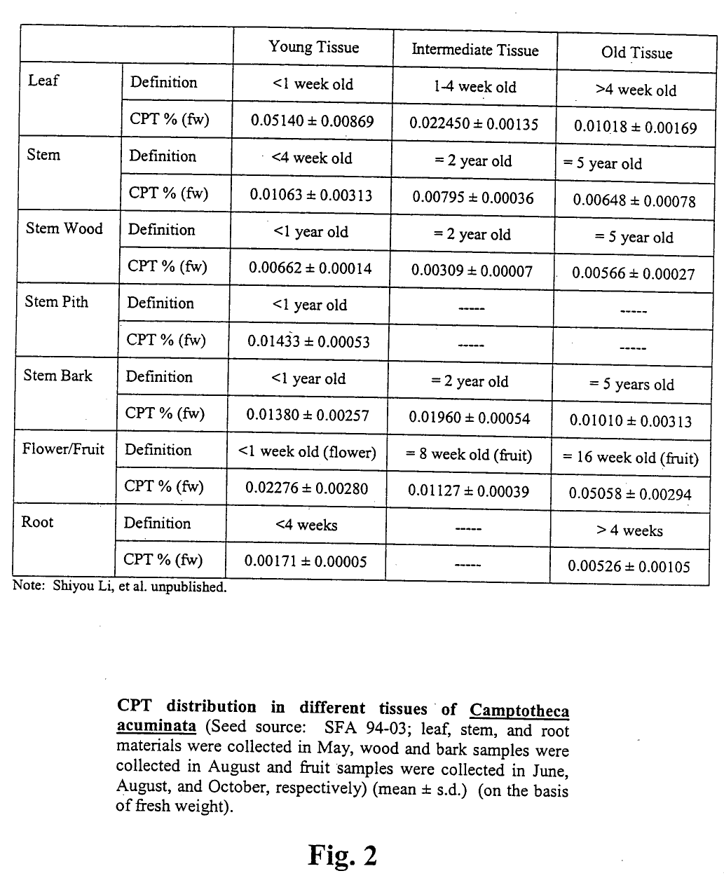

By doing further analysis on the tissues of the young leaves, the stems attached to young leaves, and the mature bark of the trees in Camptotheca acuminata, it was discovered that the tissues of the young leaves, the stems attached to the young leaves, and the bark of young stems of the trees in Camptotheca acuminata produce higher concentrations of camptothecins than the tissues of older leaves, the stems attached to older leaves, and the bark of old stems in Camptotheca acuminata as shown in FIG. 2. Specifically, it was discovered that the bark of young branches had about a 100% higher concentration of camptothecin than the wood on the interior part of the tree. In contrast, it was also found that tissues from the wood, the root, and the fruit of older trees showed a different pattern. Specifically, it was also found that the concentration of camptothecin in young roots is only about 32.5% of the concentration of camptothecin in the roots of trees. It was further found that the concentration of camptothecin in young fruit at the flower stage is only about 45% of the concentration of camptothecin in mature fruits. (As shown in FIG. 2, a mature fruit is 16 weeks old or older.) These patterns of distribution of camptothecin led to further investigation as to the exact site and the timing of the accumulation of camptothecins in Camptotheca acuminata.

Trichomes and Camptothecins

Trichomes are known to be hair-like appendages which extend from the epidermis of the aerial tissues of plants. Trichomes were one of the first anatomical features discovered by early researchers on plants. Trichomes may be unicellular or multicellular glandular or non-glandular structures and may be of several morphological types, specifically, straight, hooked or stellate.

Glandular trichomes are quite common in flowering plants. A variety of natural products, including alkaloids, terpenoids, and phenolics, accumulate in the glandular trichomes of some plants; and many of these substances appear to be produced and stored within the trichomes themselves. It is also well known that trichomes can serve to protect plants from damage by herbivores. However, studies leading to this conclusion are largely limited to major vegetable or commercial crops or specifically species with large glandular trichomes such as Nictotiana and Arabidonsis. Other research on trichomes has been directed to enhancing biological control of the plant or improving the resistance of a plant to pests or diseases.

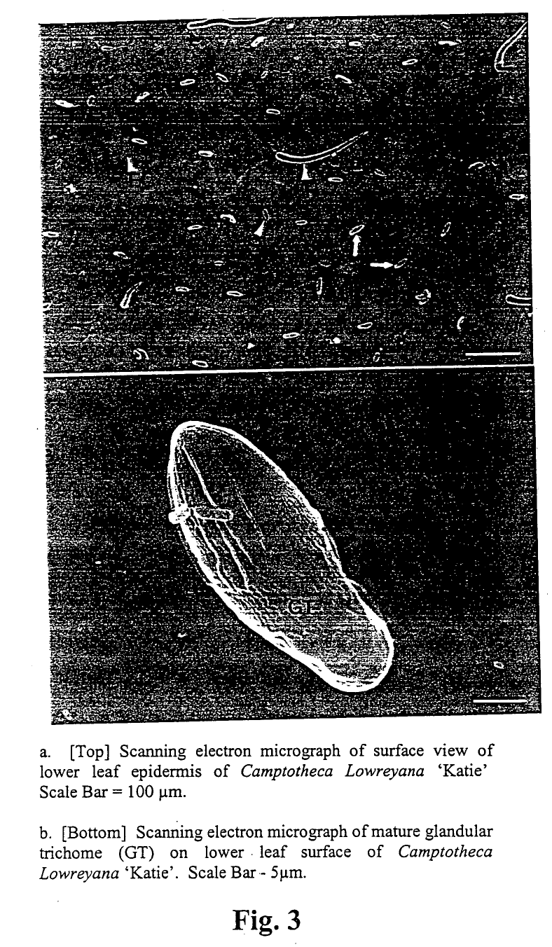

My microscopic analysis of the leaves of plants of Camptotheca (genus) revealed that the upper leaf and stem surfaces were covered with wax and only sparsely populated with global glands. However, it was found that present on the lower surfaces of the leaves of the plants in the Camptotheca genus were a plurality of trichomes as shown in scanning electron micrographs at FIG. 3. These trichomes included simple unbranched non-glandular hairs and external unicellular glands. As previously indicated, research revealed that in other plants such as Nicotiana and Solanum, glandular trichomes accumulate large quantities of secondary metabolites. It is believed that these secondary metabolites are responsible for the plant's defense against herbivores. Because it was known that camptothecin was toxic to animals and further that camptothecin could be used as an insect chemosterilant, the question remained whether or not the glandular trichomes found on the leaves of plants in the Camptotheca genus were the accumulation site for the camptothecins.

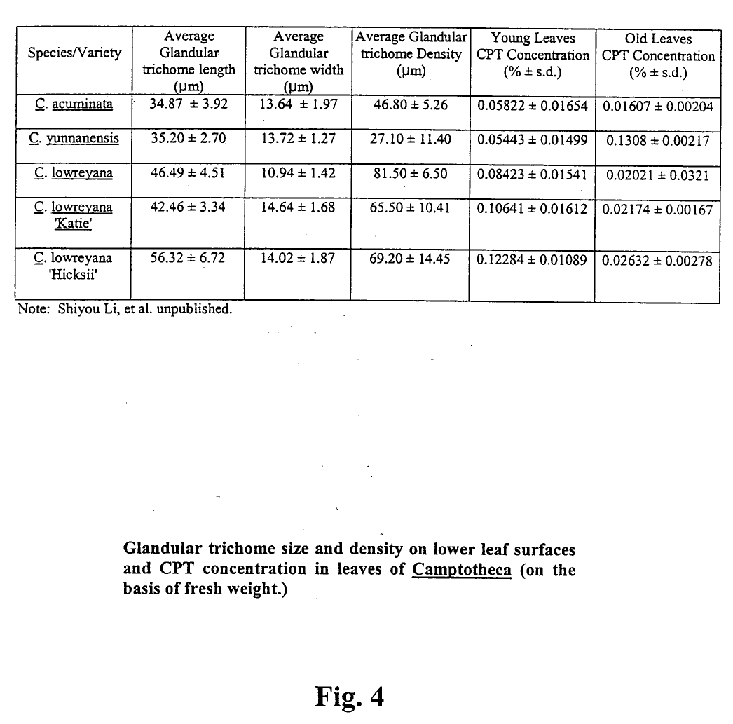

Initially, I discovered that there was a positive correlation between the concentration of camptothecins and the glandular trichome density and glandular trichome size on leaf surfaces for three species of camptothecins bearing plants as shown in FIG. 4. It is also known that the young leaves and stems in Camptotheca plants have the highest photosynthetic rates and are production sites of some hormones such as auxin and thus contributed primarily to the growth of the plant. Further, it was known that young tissues contain more tasteful materials than the older tissues and thus provided food of better quality for herbivores. I therefore determined that young tissues were the most valuable for plant growth and at the same time the most vulnerable to herbivory.

According to theories used by botanists, the most valuable part of a plant should be that part of the plant which requires the most protection against herbivores. Therefore, I expected that the young leaves of plants in the Camptotheca genus should contain higher levels of camptothecin than the older leaves. Field observations revealed that the young leaves and stems are not often attacked by herbivores. I also observed, through microscopic analysis, that the density of the glandular trichomes on young leaves and stems is much higher than the density of glandular trichomes on old leaves and stems. Further analysis of the plant revealed that glandular trichomes were not found in the interior parts of the plant, specifically the wood. Furthermore, it was found that there were low concentrations of camptothecins in the interior parts of the plants, although parenchymas in these interior parts may store certain amounts of camptothecins at certain times of plant development.

Because trichomes are not visible to the naked eye, it is difficult to do a direct analysis of the amount of camptothecins in microscopic trichomes. In searching for an alternative method for determining whether or not camptothecins were in the microscopic trichomes, I determined that when the leaf and stem surfaces were illuminated using 360 nm ultraviolet light, trichomes, particularly glandular trichomes, appeared with intense blue fluorescence. This intense blue fluorescence indicated that there were highly concentrated alkaloids, including camptothecins, in the trichomes, particularly the glandular trichomes. Specifically, this led to my discovery that camptothecins are mainly accumulated in the large vacuole or cavity within the microscopic glandular trichomes on the surfaces of the leaves and stems, particularly in the surfaces of young leaves and stems, more particularly young leaves and stems that were less than four weeks old.

Still further research into the leaves of young plants in the Camptotheca genus revealed that the concentration of camptothecin in leaves showed a different distribution pattern as the plant leaves developed and matured. Specifically, I discovered that the concentration of camptothecin in a leaf decreases as the leaf grows: 1.0:0.5:0.2 (young leaves: relatively young leaves: old leaves), as opposed to the yield of camptothecin per leaf which shows first an increase and then a decrease as the leaf grows: 1.0:3.5:2.0 (young leaves: relatively young leaves: old leaves). Accordingly, in young leaves (<one week old), the trichomes are developed and the density of trichomes (number of trichomes per unit area) is quite high. In the growth period where the young leaf (<one week old) grows to relatively young leaf (1-4 weeks old), the concentration of camptothecin based on biomass weight decreases because the density of trichomes on the leaf surface decreases which is caused both by the increase in surface area of the leaf and the growth of tissues. It is still unknown whether or not the content of camptothecins in an individual trichome increases or decreases or remains the same during this stage of leaf growth.

Once a leaf reaches a mature stage, the camptothecins bearing microscopic glandular trichomes on the surface of a leaf may experience damage or may simply detach and fall away from the leaf. Alternatively, the camptothecins may actually stay in the plant and leave the trichomes to be transported to other tissues in the plant. These factors result in the decrease of both the concentration of camptothecins bearing trichomes and the amount of camptothecins associated with any single leaf. Accordingly, I discovered that the relatively young leaves, or those leaves 1-4 weeks old, should be the focus of further efforts to maximize the harvesting of camptothecins from those plants which produce camptothecins.

Based on my research, I concluded that camptothecins are highly accumulated in the glandular trichome at the early stage of leaf or stem development, and then gradually diffuse into parenchymas of leaf and sink tissues (stem woods, roots, and fruits) via phloem. Chloroplasts may be involved in the biogenesis of camptothecins in trichomes. As secondary metabolites in vacuoles, camptothecins are influenced by hormones and thus respond to damage or environmental stresses that influence hormone level and transport. This explains the distribution pattern of camptothecins in plants.

Having discovered that camptothecins, as alkaloids which are secondary metabolites that are stored in the vacuole of glandular trichomes, the next step became to determine if the production of camptothecins might be increased by causing the plant to respond to either mechanical or environmental stress factors to induce a stronger defense mechanism in the plant to protect the plant against herbivory or pathogenic attacks. Increasing the production of alkaloids in plants by simulated herbivory

At this point in my work I also discovered that different varieties of plants in plants containing camptothecins had significant variations in the concentration of camptothecins but that all of these plants could be used as sources for camptothecins. Because I discovered that young leaves contain significantly higher concentrations of camptothecin-bearing trichomes than contained in older leaves, the management of the growth of young leaves should be the focus of further efforts. Accordingly, it was then necessary to determine if there was anything that could be done to increase the production of camptothecins by the plant by inducing the plants to increase their production of camptothecins-bearing glandular trichomes. Thus, further research was directed to increasing both the vegetative biomass, or size of the plant, containing glandular trichomes and also increasing the density of glandular trichomes contained on the vegetative tissues.

The stimulation of chemical production in plants has been extensively investigated in many plant species. Based on these investigations, the conclusion has been drawn that damage to a plant, either herbivore or mechanical damage, can result in the production of secondary components by some plants which results in a decrease in the nutritional qualities of the plants for animal life, which in turn subsequently reduces the rates of herbivore feeding. However, the hypothesis concerning the stimulation of chemical production in plants by physical damage to plant tissue has been challenged by many researchers.

For example, research on tobacco plants has revealed that tobacco plants dramatically increase the synthesis of nicotine in the underground root structure of the plant after the attack of a herbivore on the aboveground leaves. Similar findings were found with regard to the underground roots of wild radish plants by caging caterpillar larvae on the aboveground leaves.

Alkaloids of the tobacco plants, particularly nicotine, are very well studied. Scientists have long known that by inducing damage to the flowering top of a tobacco plant, the total alkaloid content of the plant is increased. By decapitating or topping the plant at the onset of the flowering process, the size, the weight, and the alkaloid content of the leaves is increased. This increase in the alkaloid content of the tobacco leaf after removal of the flowering top is largely as the result of the increased production of nicotine in the roots of the plant. Some researchers have observed increases in the alkaloid content of undamaged leaves of the tobacco plant which have been exposed to real and simulated herbivory, not herbivory to their flowering tops or herbivory to their apical or lateral buds, but to their fully extended leaves. Others have found that tobacco plants respond more to mechanical damage, either pseudosimulated or simulated herbivory, than to true herbivory by live caterpillars in terms of total leaf alkaloid content. One researcher believed that the reason for the difference between mechanical damage and true herbivory on plant response are: (1) the larvae could not chemically interfere with the ability of the plants to recognize and respond to damage; and (2) mechanical simulation of herbivory may inadequately simulate the physical properties of herbivory; actually there are temporal and spatial differences existing between real and simulated herbivory. This research on simulated herbivory led to my conclusion that the response of a plant to damage is determined primarily by the portion of the leaf removed, not merely by the amount of leaf removed in terms of surface area. Research on tobacco plants has also revealed that the alkaloidal response in tobacco plants is influenced by the timing and the amount of cellular damage rather than by the amount of leaf area lost. This research on tobacco plants has indicated that tobacco plants which are subject to gradual damage had a greater increase in the production of leaf alkaloids than those plants which had been subjected to sudden damage. This work on tobacco plants further revealed that production of alkaloids in leaves induced by damage to the leaves protect the leaves from caterpillar attack. Accordingly, I believed that mechanical damage to plants producing camptothecins might significantly affect the production of secondary metabolites over true herbivory.

Other researchers have argued that the induced response of a plant to produce secondary metabolites by damage to the plant leaves by the simulated herbivory technique of clipping the leaves is minimized by the absence of herbivore saliva. Such negative results have been found in many other plants. One researcher doing work on the production of camptothecin in the leaves of plants in Camptotheca acuminata concluded that the production of camptothecin was not stimulated by pruning treatments. However, no report was found of any correlation between pruning treatments and the production of trichomes. In addition, it is not clear whether the response of a plant to damage by producing secondary metabolites is similar in greenhouse grown or pot-bound plants over field grown plants of the same species. Still other studies reported that leaf damage affected the production of primary metabolites in plants such as proteins and sugars which caused a substantial change in the nutritional quality of leaves.

On the Role of Plant Hormones in the Production of Alkaloids

To further understand plant response; more specifically the production of camptothecins, further work in this area centered on the role of plant hormones in the production of alkaloids.

Three plant hormones (auxins, cytokinins, and gibberellins) are known to promote and regulate the growth of a plant, and two plant hormones (abscisic acid and ethylene) are known to either inhibit plant growth or promote plant growth to maturity.

Auxins are produced in the tips of developing leaves and stems. The auxins then diffuse from their sites of production downward in the plant toward its roots. It is well known that auxins have multiple functions; specifically auxins augrnent the growth of the plant by cell elongation, inhibit the growth of lateral buds, foster the growth of the ovary wall, prevent droppage of leaves and fruits, and orient the growth of roots and stems. Indoleacecetic acid (IAA) is the best known naturally occurring auxin in plants, and both 2,4-dichlorophenoxy acetic acid (2,4-D) and naphthalene acetic acid (NAA) are synthetic auxins. 2,4-D is widely used as an herbicide, while NAA is commonly used to induce the formation of adventitious roots in cuttings and to reduce fruit drops in commercial plants.

Cytokinins generally stimulate cell division, including cytokinesis. Unlike auxins, cytokininis promote the growth of lateral buds but not stem tips. Cytokininis also have other effects in plants to include the prevention of leaf aging or senescence. Cytokinins move upwardly in the plant from the root to the shoot. At present, cytokinins (e.g., kinetin) are commonly used in tissue/culture medium. Experiments have shown that kinetin alone has little or no effect on plants. IAA plus kinetin resulted in rapid cell division and switched the cells into a meristematic course.

Gibberellins are made in a variety of organs in the plant, such as young leaves, embryos, and roots, and move more passively through the plant. Gibberellins are primarily involved in regulating plant height. Too little gibberellin results in dwarf plants, but too much gibberellin results in long, pale stems. Gibberellins also promote seed germination and are involved in both flowering and fertilization, growth of new leaves, growth of young branches, and growth of fruits. Of the more than 80 different gibberellins known, the most commonly used in experimentation is the fungal product gibberellin acid (GA₃). It is thought that the plant hormone Abscisic acid (ABA) counteracts the plant growth hormones by indirectly blocking protein synthesis and new growth. ABA begins forming when the plant senses an environmental stress such as drought. ABA moves only short distances within the plant from its site of production. The main role of ABA is to induce and maintain metabolic slowdown, or dormancy, in the plant, especially in buds, and the closing of the stomata of a leaf to prevent excess water loss as well as to accelerate the dropping of leaves and fruits. It appears that ABA and GA₃ can sometimes act antagonistically. For example, ABA inhibits stem growth, while GA₃ promotes stem growth; ABA promotes dormancy and GA₃ relieves it. Since both ABA and GA₃ are derived from a common chemical precursor, mevalonic acid, the biochemical branch point leading to the synthesis of one hormone or the other determines many aspects of the plant's subsequent growth behavior.

Ethylene is a gas whose molecules contain only two carbon atoms. Ethylene is dispersed from one plant or plant part to another plant or plant part through the air. The hormone ethylene is produced by ripening fruits. Ethylene also stimulates ripening in nearby fruits. In addition, ethylene also stimulates the aging and dropping of leaves and fruits by a plant and may have an important role in plant self-protection.

The correlation between hormones and alkaloids in plants has been studied in cell suspension cultures of both Catharanthus roseus and tobaccos. It seems clear that at least the alkaloids in cultured cells of these two plant species are determined by the plant hormone auxin. It has been found that a change in the amount of the plant hormones cytokinin and auxin (for example, the removal of 2,4-D) stimulates the production of secondary metabolites in cell culture of Catharanthus roseus. It has also been found that plant cells cultured in the presence of auxin did not accumulate alkaloids in the same species. The addition of exogenous methyl jasmonate to plant cells restored the ability of the plant cells to produce alkaloids.

Other studies have shown that genes encoding an enzyme essential for indole alkaloid biosynthesis are rapidly down-regulated by the level of auxin in cell suspension cultures of Catharanthus roseus. It has been found in tobacco plants that with low levels of IAA (c. 1 :M) little callus grows, but the production of pyrrolidine alkaloid increases. At higher levels of LIA (c. 10 :M), it has been found plant growth is stimulated and the synthesis of alkaloids falls. No research appears to have been done on the correlation between the level of plant hormones and the production of camptothecin.

As plant growth regulators, plant hormones are used extensively in agriculture because of their positive influence on the quality and quantity of crops. The reported research appears to be inconclusive that some common plant hormones, NAA, 2,4-D and GA₃, affect the density of glandular trichomes with regard to the yield and composition of essential oils in aromatic plants or with regard to alkaloidal response in plants.

It is my conclusion that by controlling (physically, biologically, or ecologically) the amount of hormones produced by the plant, the amount of alkaloids, including camptothecins, produced by the plant could be increased. For example, by reducing the amount of auxin produced by a plant using mechanical or environmental factors, the amount of camptothecins produced by the plant can be increased.

On Environmental Factors and the Production of Plant Alkaloids

Some researchers have hypothesized that a number of environmental factors influence either a plant's trichome density or its chemical response.

Water Stress

The contribution of trichomes to drought avoidance may be critical under some circumstances. It has been reported that trichomes improve leaf water status by entrapping and retaining surface water, thus assisting in the final absorption of water into the mesophyll in Phlomis fruticosa. On the other hand, water stress in both soil and air may stimulate trichome formation in some plants. For example, it has been reported that wheat has significantly denser trichome growth under low soil moisture conditions. Similarly, it has been reported that severely water-stressed Taxus x media ‘Hicksii’ produced significantly more taxanes and ABA than did the less water-stressed plants. Another researcher found that Sinapis arvensis might increase trichome density to decrease water loss under drought. In contrast, conditions of low evapotranspiration (high humidity and low temperature) not only could slow but also may even truncate the induced response because low evapotranspiration will greatly slow the water loss from plants and consequently the transport of alkaloids to the leaves from the roots. It has also been reported that flooding led to significant decreases in leaf biomass but had no effect on camptothecin concentration in leaves or stem in Camptotheca acuminata.

On the Mechanisms of Plants in Response to Stress

Current hypotheses to explain how secondary metabolites change after damage to a plant can be classified as either supply-side or demand-side.

Supply-Side Response Hypothesis

The supply-side hypotheses posits that secondary metabolites accumulate in response to imbalances between growth-related processes and metabolite production. According to the supply-side hypothesis, plants do not regulate the production of secondary metabolites to any extent, and plant defenses are most influenced by the availability or supply of secondary metabolites within the plant. The growth/differentiation balance hypothesis posits that all secondary metabolites have an ontogenetically determined phenology and that their synthesis is emphasized during periods of plant differentiation. The process of plant growth largely occurs during different times than the processes of differentiation that produces resin ducts, trichomes, spines, and so forth. The “carbon/nutrient” model attempts to explain induced changes in secondary metabolism as a result of imbalances between carbon and nutrient requirements for growth and the availability of these resources from the external environment. According to this hypothesis, only when resources exist in excess of growth requirements are they shunted into secondary metabolism. Plants with an excess of carbon relative to nutrients are predicted to have reduced nitrogen-based secondary metabolites such as alkaloids. In contrast, environmental factors such as nitrogen fertilization and shade that leaves plants with shortages of carbon relative to nutrients are predicted to increase nitrogen-based secondary metabolites and reduce carbon-based secondary metabolites. The “substrate/enzyme imbalance” hypothesis argues that secondary metabolites accumulate because of “overflow” metabolism, and emphasizes differential enzyme compartmentalization and regulation. Both carbon/nutrient and substrate/enzyme hypotheses present induced metabolites as being essentially “waste products”, neither hypothesis precludes the “defensive” sculpting of the overflow metabolites.

Demand-Side Response Hypothesis

The demand-side hypotheses of how secondary metabolites change after damage to a plant posits that damage results in biological signals within the plant that directly regulate secondary metabolism. The demand-side hypothesis is built on the premise that concentrations of secondary metabolites are mostly strongly influenced by the plant's need or demand for defense. The generalized stress-response theory argues that plants have hormonally mediated centralized system of physiological responses for coping with many diverse stresses. Optimal defense theories predict that the most valuable parts of a plant should be most protected against herbivores. The value of a plant part is defined by its contribution to the overall fitness or health of the plant. During the reproductive phase, flowers and seeds represent the closest approximation to fitness. Indeed, it has been found that flowers and seeds often contain the highest levels of defensive secondary metabolites within the plant. During the vegetative phase, young, fully expanded leaves have the highest photosynthetic rates and thus contribute most to growth. It is also found that these young leaves often contain more defense chemicals than older leaves. It is also believed that there are two systems which affect the optimal distribution of alkaloid defense systems in tobacco plants; a damage response system that triggers an increase in root alkaloid synthesis, and an internal plant plumbing system that ensures greater transport of alkaloid-containing xylem fluid to younger leaves.

The active defense response theory is similar to the demand-side hypothesis but posits far more specificity in the plant's signaling system. The active defense response theory postulates that endogenously produced plant damage signals or plant damage signals specific to the invading organism activate specific defense responses in a plant. The rapidly induced increases in the production of secondary metabolites in plants result from specific signals which control the metabolic pathways that produce the chemical defense response in plants. It is found that sucrose, the major form of sugar transport in the vascular system of a plant (phloem) provides a biological signal. A plant responds to the biological signal of sucrose by increasing or decreasing nutrient flow from the leaves to the roots, the seeds, and plant storage organs known as “sink” tissues. RNA molecules may also carry biological signals long distances within plant via phloem, which has been called the “plant information superhighway.”

Because the active defense theory is the most likely model, it can be used to determine how to stimulate the production of camptothecins from plants. Accordingly, hormones play more important roles in trichome formation and alkaloid biosynthesis and transport in plants than previously known or expected. To understand the correlation between hormones and secondary metabolites, specifically alkaloids, is critical to developing strategies for inducing the production of alkaloids in plants. It is difficult to present one model for the correlation between hormones and the formation of trichomes or the production of alkaloids in all plants because different species respond differently and different hormones may have different mechanisms which affect individual alkaloids. In some cases, alkaloids may also be important in hormone biosynthesis and transport. It is my conclusion that the growth promoting hormones (auxins, gebberellins, and cytokinins) inhibit biosynthesis of alkaloids while other hormones (ABA and ethylene) stimulate the biosynthesis of alkaloids. For example, removal or decrease of auxin (IAA) will enhance the yield of indole and quinoline alkaloids in some plants (e.g. Catharanthus roseus and Camptotheca acuminata). It is not only true in cell culture of Catharanthus roseus cell culture, but it was also found valid in experiments with Camptotheca plants.

It is my belief that the interrelationship of hormones and alkaloids is also present in the production of alkaloids by cell culture for all plants. It is critical to balance the amounts of hormones to successfully induce alkaloid production in plant cell cultures. As previously indicated, IAA is produced in shoot apical meristems, developing leaves, and reproductive buds and it has functions of cell elongation and inhibition of growth of lateral buds (dominance). Thus, a plant's response to damage is determined by age and location of tissues, not merely by how the tissue is removed or how much of the tissue is removed.

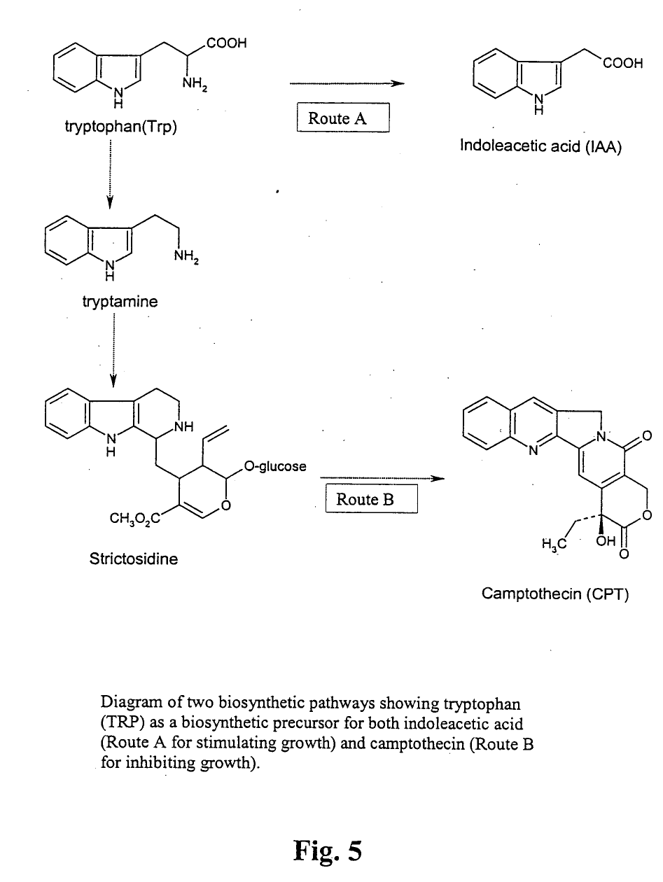

My experiments showed that any treatments which removed or decreased IAA in plants (e.g., pruning shoot tips particularly the dominant shoots, pinching leaf tips) will stimulate the production of camptothecins in Camptotheca. This explains why there is no inducing the production of alkaloids in plants by some other pruning, pinching, or herbivory treatments that do not involve the young stem and leaf tips. This also explains why multiple shoot or slow-growing plants usually have higher alkaloidal yield. It is not clear how hormones inhibit the indole/quinoline alkaloids in plants. But tryptophan is a biosynthetical precursor for both indole/quinoline alkaloids and IAA as shown in FIG. 5. The IAA route represents stimulating growth while the camptothecin route represents inhibiting growth. Accordingly, I discovered that camptothecins act in plants just like a hormone. Some indole and quinoline alkaloids inhibit the cell growth through DNA Topo I enzyme or production of auxins in plants and thus are cytotoxic (anti-tumor). Camptothecins, vinblastine, and vincristine are examples. Some environmental stresses (drought, extreme temperatures, and radiation) may stimulate alkaloidal production due to increase stress hormone (ABA) level. My experiments showed all these stresses have a positive effect on inducing the formation of trichomes and accordingly the production of camptothecins in Camptotheca.

On Increasing the Production of Camptothecins

To date, there are no studies available on the biological mechanism for induction of camptothecins production in Camptotheca.

Strategy—Develop a New Cultivar

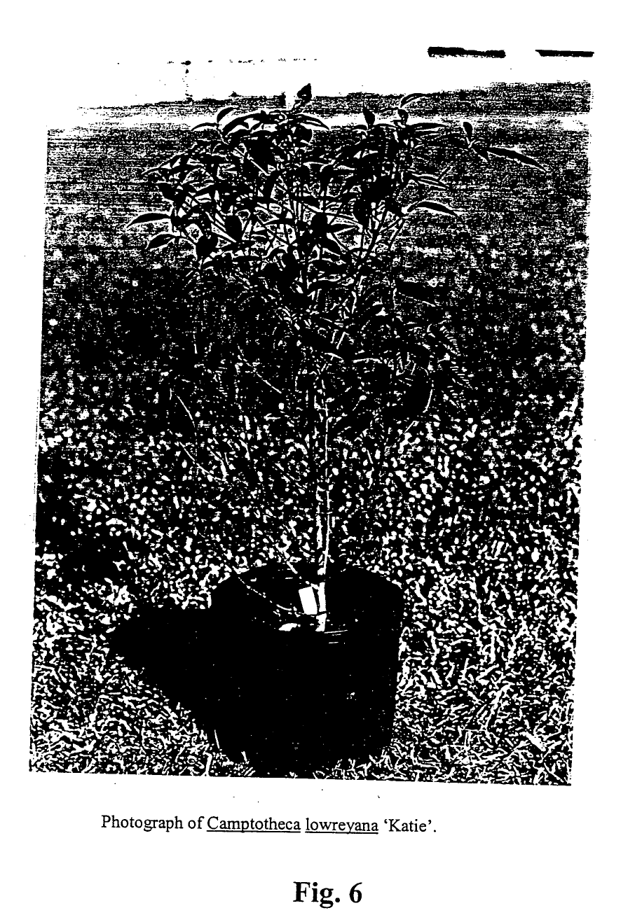

The first strategy to induce the formation of trichomes and the production of camptothecins in plants involved the creation of a new cultivar. This cultivar, Camptotheca lowreyana ‘Katie,’ is disclosed in my co-pending plant patent application which is incorporated by reference herein. This new cultivar is distinguished by its vigorous and dense multi-branching growth habit and its small and lanceolate or elliptical leaves (shown in FIG. 6) with smooth margins in both the juvenile and mature stages of plant growth. It was found that the ‘Katie’ cultivar had a significantly higher yield of camptothecins. Specifically, it was found that this new cultivar produced a significantly higher yield of camptothecin (0.1064% on a fresh weight basis) in its leaves and is more hardy and drought tolerant than any naturally occurring Camptotheca variety.

Strategy—Pruning Techniques

The second strategy for stimulating the formation of trichomes and the production of camptothecins involved the development of T-pruning techniques to decrease auxin levels within the plant.

On Pruning in General

It is well known that the pruning of a plant is the process of removing a part or parts, living or dead, from a living plant. The main purpose of pruning is to keep plants healthy and attractive, to control plant size, to improve the quality of flowers, fruits, foliate or stems, and to reduce hazards to the plant.

Pruning is a technique that has long been used in horticulture and forestry on landscape plants, fruit plants, and timber trees worldwide. It is well known that pruning, if properly done, can greatly increase the biomass growth of a plant over an un-pruned plant. Specifically, it has been reported that removal of the five uppermost immature leaves or short tipping after 20 to 25 cm. of terminal growth in apple trees can produce more lateral bud break than are produced on non-treated shoots.

Apical dominance is a basic principle of plant pruning. The terminal bud on a plant produces the hormone auxin which inhibits the growth and development of lateral buds. When the terminal bud on a plant is removed by pruning, the lateral buds and stems below the terminal bud grow vigorously. Because auxin moves downward in the shoot of the plant, apical dominance is strongest in the vertical or upright shoots or limbs of the plant. For vertical shoots or limbs, the most vigorous new growth occurs within six to eight inches of the pruning cut. However, regrowth on limbs having a 45° to 60° angle from the vertical will develop farther away from the pruning cut.

On Pruning Techniques

There are several basic types of pruning techniques commonly used in landscape plants. The type of pruning called thinning is the removal of connecting branches at their point of origin or shortening the length of a stem by a lateral cut. Thinning will make a plant grow taller and more open. Heading (also known as topping, rounding over, dehorning, capping and hat-racking) is the pruning of large upright stems between their nodes to reduce the height and increase the density of the plant. A selected heading cut removes a large portion of a stem, while a non-selective heading cut (also known as shearing) removes all the stem tips on a level plane. Tipping is the practice of cutting lateral stems between nodes to reduce crown width. Both heading back and tipping are recognized as poor plant maintenance techniques which harm trees and should not be used in regular tree pruning.

Also, it has been reported that stem tipping has resulted in the highest number of stems and greatest total stem length. In tea bushes, pruning is an essential agronomic practice to maintain the tea bushes in a manageable condition for plucking. However, it is not clear if pruning induces chemical production in medicinal plants. Existing data on the effect of pruning on the chemical production in medicinal plants is contradictory.

Pinching

The technique called pinching is a common technique for training perennial herbaceous plants. In pinching, the thumb and forefinger is used to remove very soft growth; typically, whole buds, leaves or stems throughout the growing season. The technique of pinching is used to avoid future pruning, to redirect growth, to increase the density of the plant, or to disbud flower and thin fruits.

Rubbing

The practice of rubbing refers to rubbing off undesirable buds, such as sprouts on the trunk or scaffold branches on a fruit tree or any young growth that seems to be growing in the wrong direction.

Studies on the effect of damage by pruning or defoliation on the density of trichomes on plants are inconclusive.

On Pruning and Increasing the Production of Camptothecins

While the young leaves of the Camptotheca acuminata have been harvested for the production of camptothecin, there is no suggestion of any effort being made to stimulate or increase the production of camptothecin by the plant leaves. It was reported that the yield of camptothecin was 14.58 mg per plant in a six-week period. It was also reported that the yield of camptothecin was not constant from plant to plant. Specifically, a camptothecin concentration range (from 0.045% to 0.349% on a dry weight basis) was reported.

Because of the reported production of camptothecin in Camptotheca acuminata, another strategy for stimulating trichome formation and camptothecins production in Camptotheca centered on developing pruning techniques. Specifically, these pruning techniques were directed to maintaining the Camptotheca plants in a low and compact form to stimulate both the biomass yield of young vegetative tissues and to increase the amount of camptothecins in these young tissues.

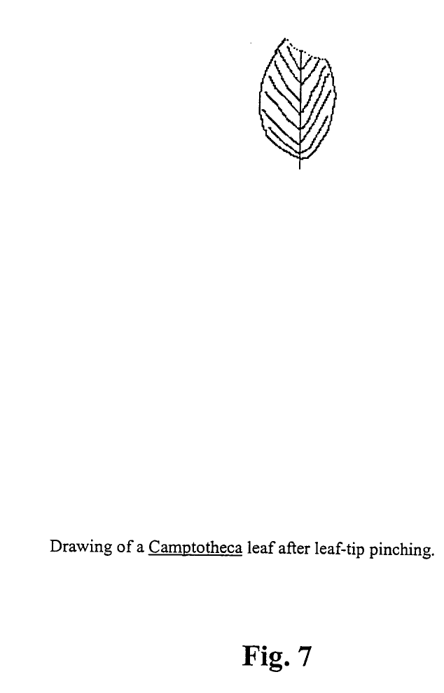

It was discovered that the systematic pruning of young stems decreased the level of the plant hormone auxin (LAA) and produced a denser, more compact plant with increased biomass production of young stems and leaves. Specifically, by systematically pruning the plant, that is, stem pruning the plant four times during the first year and pinching off the end portion of the leaf as shown in FIG. 7 before each harvest, and then continually harvesting the plant eight to ten times after the first year of the pruning treatment, additional flushes of stem growth appeared several times during the year. Because the new plant shoots caused by pruning in the late summer or pruning in the fall could easily be damaged by an early frost, late summer or fall pruning is generally not suggested. It was found, however, that frequent harvesting of young tissues avoids the potential of frost damage. The systematic pruning and frequent harvesting of young tissues from Camptotheca minimizes the reduction of the next year's reproductive growth and thus increases the vegetative growth or biomass of leaves and stems and the accumulation of camptothecins in the leaves and stems of the plant.

It is well known that the leaves of a plant are regulators of the plant's response to stress. It is well known that the production of trichomes, and accordingly, secondary metabolites by plant leaves can be induced by herbivory. The leaves of Camptotheca plants can be attacked by insect larvae or small animals such as goats or deer. In some cases, new, almost fully spread leaves and stems, are more toxic after herbivory. Apparently, the presence of toxic camptothecins in young Camptotheca leaves is induced by herbivory. However, herbivory damage to mature leaves does not appear to decrease the level of the plant hormone auxin significantly. As a result, the production of camptothecins by the plant is limited. The content of camptothecin with herbivory is not significantly higher than a plant without herbivory: 0.0381%±0.0096 (with herbivory) vs. 0.0514%±0.0065 (without herbivory) in young leaves, 0.01711%±0.00383 (with herbivory) vs. 0.01790%±0.00132 (without herbivory) in relatively young leaves, and 0.00984%±0.00089 (with herbivory) vs. 0.009335%±0.00086 (without herbivory) in young stems. Therefore, it was determined that uncontrolled herbivory is not an optimum strategy to enhance the formation of trichomes and production of camptothecins.

On Specific Pruning Techniques

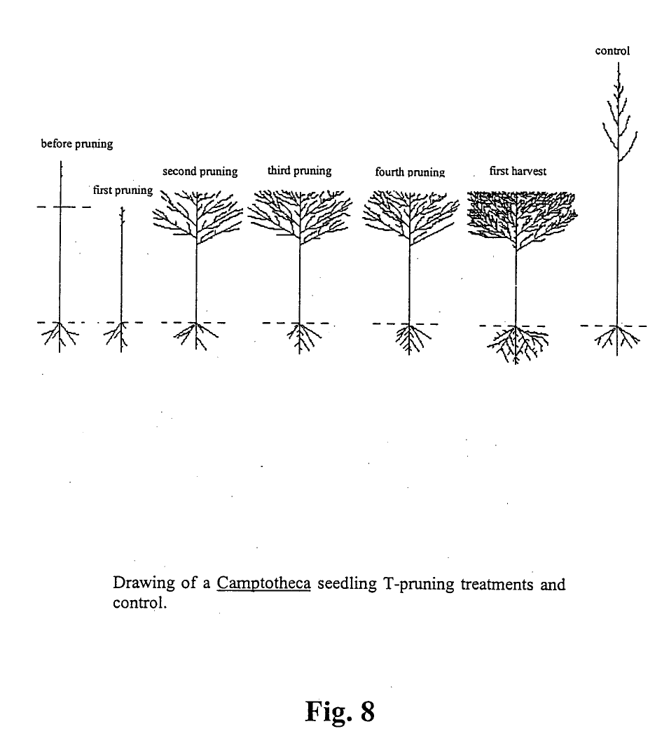

The pruning techniques of the present invention, called T-pruning, control the growth of the Camptotheca plants to a low and compact form for stimulating the development of young tissues, the increased formation of glandular trichomes, and the production of camptothecins. The present T-pruning technique, as shown in FIG. 8, uses both summer and fall pruning after a spring pruning in the same year. This summer and fall pruning stimulates additional flushes of stem growth in Camptotheca plants and thus enhances the formation of glandular trichomes and the production of camptothecins in the vegetative tissues. The young stems on the plants can be damaged by an early frost, but harvesting avoids this problem. To reduce frost damage, the first pruning is preferably done in March after the last frost.

The disclosed T-pruning techniques can be applied to any age seedling with either sexual or asexual origin, preferably 1-3 year old healthy seedlings are best for the application of the T-pruning techniques of the present invention.

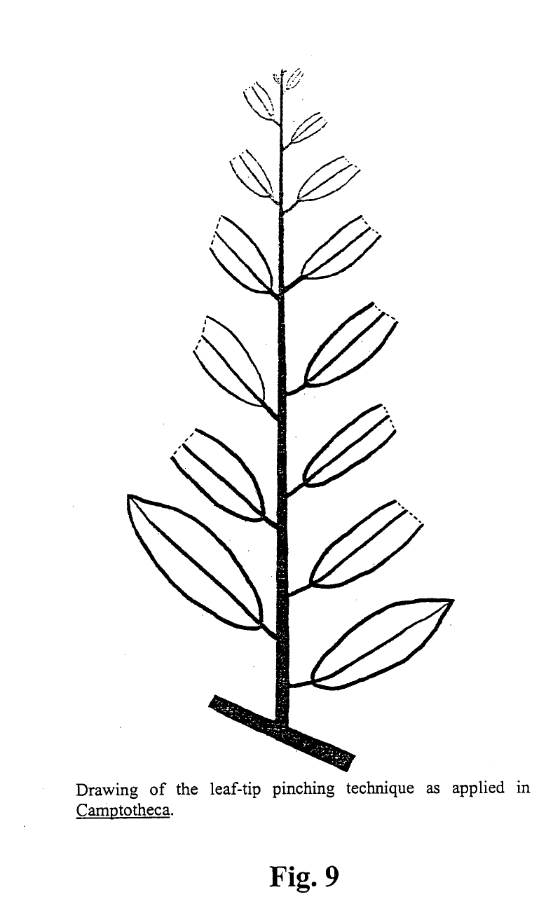

The first pruning in the T-pruning sequence should take place immediately after the last frost. If plants have no dormancy or frost damage in certain regions or conditions (e.g., no low temperatures), or, in other words, plants grow during all seasons, the first pruning can be done in any time of any season and the fourth pruning can be done in less than one year. The first pruning is accomplished by heading back a young unbranched shoot to less than about 50 cm. of the ground with either pruning shears or lopping shears. The pruning cut is made on a slight slant a quarter inch above a healthy bud. The bud should be facing the direction preferred for new growth. This pruning technique will force 2-7 buds back below the cut into vigorous, upright growth in 1-2 weeks. Two or three weeks after the heading, root pruning can be used to produce a more compact plant. Root pruning is accomplished using a straight-bladed spade or other mechanical device. One-third of the root system is pruned away, then after four or five weeks a second one-third of the root system is pruned away and then 4-5 weeks later, the other third of the root system is pruned away. At the same time as the root pruning, the thumb and forefinger or mechanical leaf tip pinching techniques are used, leaving 1-2 old leaves per stem with the pinched leaves still remaining on the branches, as shown in FIG. 9.

The second pruning is accomplished 12-20 weeks after the first pruning. The second pruning may be accomplished using scissors or shears and heading back stems with a cut angle less than 30° from the main stem to 50 cm. from the ground, heading back those stems between 30° and 70° from the main stem to the third buds from the stem tip while only tipping the terminal bud from those stems with angles more than 70° from the main stem. Stubs are rubbed off the plant. After the pruning, the tips of the one or two remaining leaves per stem are pinched and the previously pinched leaves remain on the stem. The undesirable buds are rubbed off below the sixth stem.

The third pruning occurs 8 to 12 weeks after the second pruning.

Using scissor-action shears, those stems with angles less than 30° from the vertical are headed back from the main stem to 50 cm. from the ground, heading back those stems between 30° and 70° from the main stem to the third buds from the tip of the stem while only tipping the terminal bud from those stems more than 70° from the main stem. Once again, stubs are rubbed off. After the T-pruning, the tips of the one or two remaining old leaves per stem are pinched off, and the cut leaves are left on the stem. Once again, the undesirable buds below the sixth stem are rubbed off.

Before any early frost, new growth should be pruned to avoid frost damage.

The fourth pruning occurs in the second year immediately after the last frost. Using scissor-action shears, those branches with angles less than 30° from the main stem are headed back to within 50 cm. from the ground. Those stems between 30° and 70° from the main stem are headed back to the third buds from the stem tips, while only tipping the terminal buds from those stems more than 70° from the main stem. Once again, stubs are rubbed off. All dead branches are removed. The undesirable buds below the sixth stems are rubbed off. After the pruning, the tips of the one or two remaining old leaves per branch are pinched off, and the leaves with tips pinched off are left on the trees after the new leaves come out.

After the fourth pruning, the intact young tissues can be regularly harvested manually or mechanically. Each harvest is equivalent to an application of T-pruning. The tips of the leaves should be pinched off 2 to 15 days before each harvest. 10% to 30% of leaf blade areas of 20% to 60% of all of the leaves on each stem should be pinched off with fingers or an equivalent mechanical method. This leaf-tip pinching technique may be applied during any year of plant growth.

It has been found that each harvest also serves to prune the plant and to induce biomass growth and the formation of trichomes as well as the production of camptothecins for the next harvest. This continual pruning and harvesting creates a sustainable system for a long-term harvest of camptothecin.

The effect of the disclosed T-pruning techniques are detailed in Example 1. Note that the content of camptothecins in intact young tissue from the Camptotheca plants was significantly increased by the disclosed T-pruning method. In addition, the annual biomass yield of young tissue by the plant was also significantly increased by the disclosed T-pruning method. Other natural existing camptothecins, including 10-hydroxycamptothecin will be significantly increased by the disclosed T-pruning method.

After each stem pruning or harvest of young tissue, the thumb and the forefinger are used to pinch off the tip or about 20% of the whole blade leaf area, leaving about one or two old leaves per branch while leaving the leaves with the pinched off tips on the stems. It has been found that this technique of pinching off the tips of leaves induces both the formation of glandular trichomes and the production of camptothecins. Accordingly, the disclosed process of using a leaf tip pinching off technique for the pinching off of leaf tips to imitate herbivory by insects and small animals induces the formation of trichomes and the production of camptothecins. Previously, pinching has only been used as a common technique related to training herbaceous landscape plants where whole buds, leaves, or stems are removed from a plant to avoid future pruning, to redirect growth, to increase the density of the plant, or to disbud flowers and to thin out fruits.

The Plant's Reaction to Leaf Pinching

It has been found that there are two peaks of stimulating the production of camptothecins by pinching off the tips of the leaves over a certain time period for any part of young plant tissues as shown in Example 2. The existence of two peaks suggests that there are two steps of defensive response by the Camptotheca plants to damage; a first emergency defense, and then a long-term defense. The first emergency defense response occurs two or three days after the pinching off of the leaf tips. As a result of the first emergency defense against plant damage, the plant increases its content of camptothecins in young tissues, particularly young leaves, largely at the cost of the camptothecins in older tissues. Thus, the total content of camptothecins in a whole plant does not change significantly during the emergency defense. Thus, an emergency response by the plant may produce a false increase of camptothecins yield in a whole plant. After the emergency response by the plant wanes, the long-term response by the plant occurs about six or eight days after the pinching off of the leaf tips. Therefore, the optimum time for the leaf tip pinching is at least about six to about eight days before each harvest.

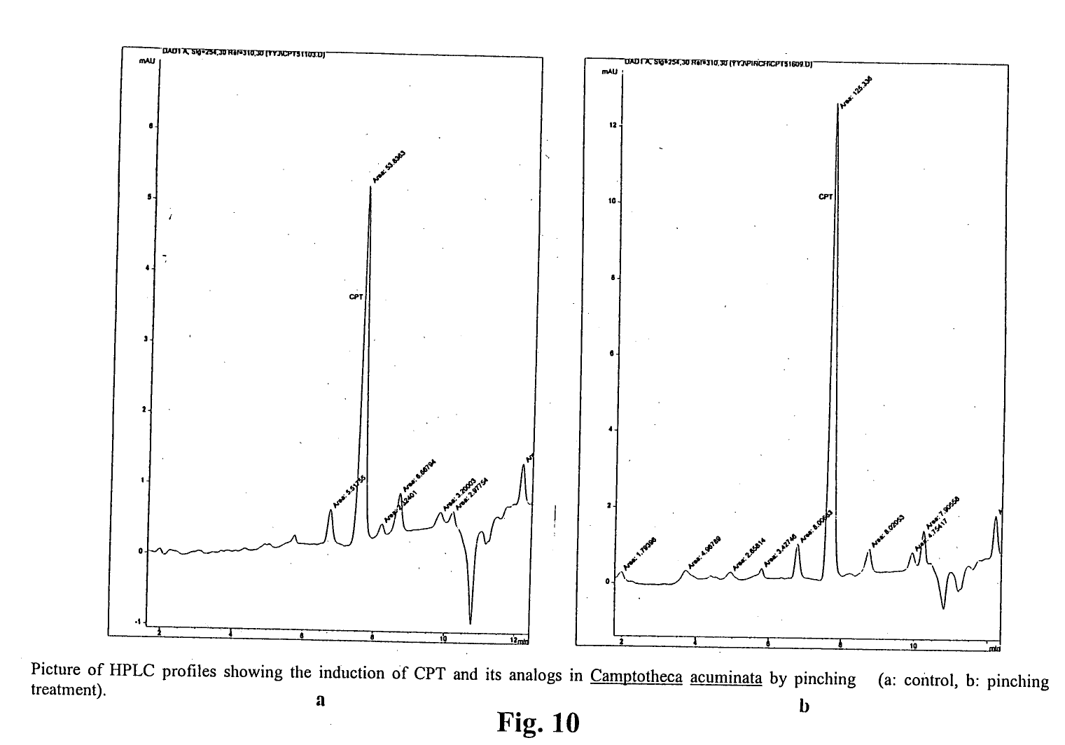

The long-term defense produces a greater increase in the overall amount of camptothecins in both young and old tissues. Thus, the camptothecins content increases significantly in the whole plant. To reach the maximum and stable yield of camptothecins, it is preferred to harvest plant materials after the long-term response by the plant begins. The start time of the long-term response by the plant may increase with plant age and plant size. Induced production of camptothecins in the plant is related to the hormone level in the plant. Thus, the pinching of the leaf tips is more important than the amount of cellular damage or the amount of leaf area lost. The pinching off the tips of young leaves reduces the level of the plant hormone auxin and enhances camptothecins production. It also increases the production of camptothecin analogs as in FIG. 10.

On Environmental Stress Factors and the Production of Camptothecins

As previously indicated, it has been reported that environmental stresses influence the production of secondary metabolites in some plants. However, these environmental stresses can have negative effects on plant growth while having a positive influence on the production of secondary metabolites. Thus, any plant's response to environmental stresses varies with the environmental stress to the plant species. Because of the nature of the Camptotheca plants, environmental factors, such as water stress, as shown in Example 3, increases the formation of glandular trichomes and the production of camptothecin. The results of the effects of light intensity are also shown in Example 3.

On Harvesting Intact Clippings

To keep harvested plant materials fresh for long periods of time and thus better preserve the trichomes which contain the camptothecins, it has been found that young leaves should be harvested with stems. The combination of young leaves with their attached stems is termed an intact clipping as shown in Example 4. Intact clippings include any clipping in which a substantial amount of the original foliage or leaves remain attached to the stems. The intact clippings harvested according to the present invention are mostly 3-20 days old. It has been found that harvesting intact clippings better preserves trichomes and the camptothecins content in leaves and stems. In addition, more camptothecins exists in intact clippings than in old leaves.

The harvesting of the intact clippings can be started in late March or early April in the second year after the first pruning as shown in Example 5. It is preferred to have 10-12 harvests annually with about two to four weeks as the harvest cycle. In some warmer climates more harvests may be possible due to the longer growing period.

It has been reported by others that in Camptotheca acuminata the concentration of camptothecin in leaves declines at 11% each month from April to October, and the camptothecin concentration in leaves decreases significantly with tree age; 16 times lower in 4-year-old trees than in 2-year-old trees. It has been hypothesized that camptothecin defense mechanisms are programmed for early ontogenic stages in Camptotheca acuminata.

My study determined that there is no significant change in the content of camptothecins with tree age using the pruning and harvesting system of the present invention as shown in Example 6. Accordingly, Camptotheca trees pruned and harvested according to the present invention will yield camptothecins for many years. There will be significant seasonal change of the content of camptothecins in the young tissues of the plant during the growing season as shown in Example 7. The highest camptothecins yield will occur in the middle of the growing season. Both camptothecins yield and the biomass of intact young tissues can be improved with proper irrigation, particularly during dry months. It has been found that each plant can produce 600-800 mg of camptothecin annually which is about 7 to 9 times of the production of camptothecin using existing methods.

On Preserving the Harvested Materials

Once harvested, the intact clippings can be processed while fresh within the first two days after harvesting or after a longer period, up to several years, if frozen, as shown in Example 8. Specifically, freezing may take place in a conventional freezer or by placement of the intact clippings in liquid Nitrogen.

In most studies involving Camptotheca plants, oven-dried plant materials have been used for determining the presence of camptothecin. Contrary to the existing practice of oven-drying, I have found that fresh or frozen plant materials from the Camptotheca plants have the highest content of camptothecins as compared to air-dried or oven-dried plant materials. Still further research revealed that glandular trichomes experience less damage or destruction by freeze-drying than by air drying or oven drying at 65° C. in experiments to extract the camptothecin from the vegetative tissues of the plant. Specifically, it was found that the yield of camptothecin was much higher when freeze drying techniques were used than with other plant drying methods.

On Recovery of the Camptothecins

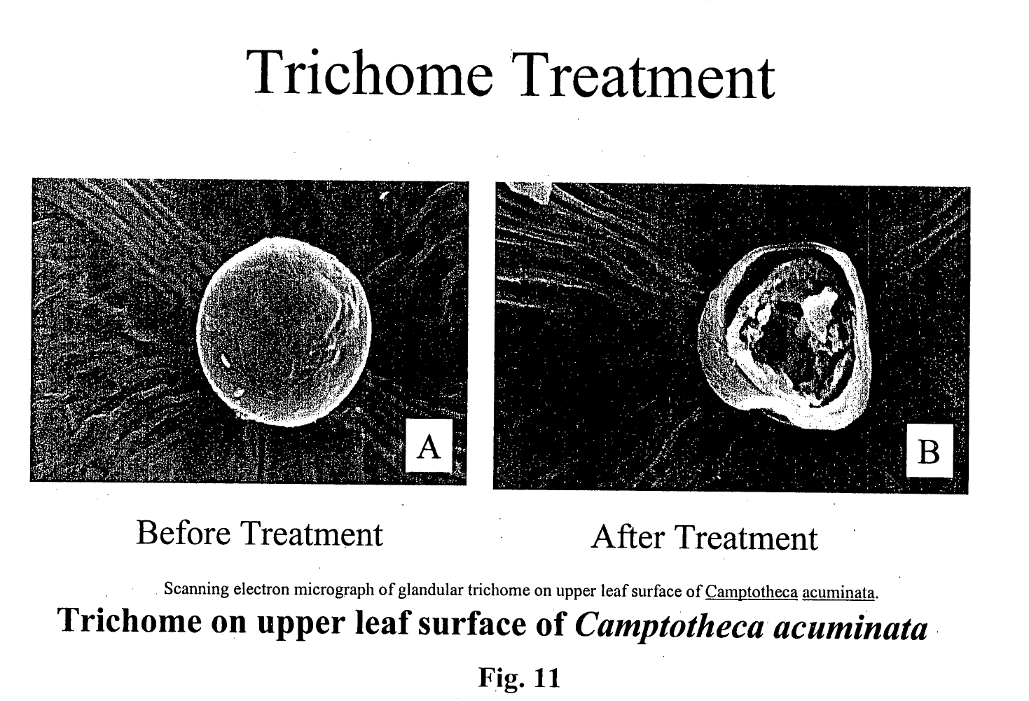

The final step involves recovering the camptothecins from the trichomes. To accomplish this recovery of the camptothecins from the trichomes, it is necessary to break the wall of the glandular trichomes found on the young leaves and stems as described in Example 9 and as shown in FIG. 11. The walls of glandular trichomes are generally found to be much thicker than those of surrounding plant epidermis. Manual grinding techniques such as the use of a mortar or grinder do not effectively break the trichome walls. The use of an ultrasonic processor to break trichome walls is more effective, as approximately 80% of the plant glandular trichome walls were broken.

The use of a homogenizer having a peripheral speed of 26 meters per second for 120 seconds increases the extraction rate of camptothecin.

Still other mechanical techniques such as those using the action of moving small glass spheres may also be used to break the trichome walls to recover the camptothecins.

What is claimed is:

1. A process for increasing the production of camptothecins by a plant comprising the step of:
physically, biologically, or ecologically controlling the amount of hormones produced by the plant.

2. The process as defined in claim 1 wherein said physical, biological, or ecological control of the amount of hormones produced by the plant includes reducing the amount of auxin produced by the plant.

3. The process as defined in claim 2 wherein the amount of said auxin produced by the plant is reduced by removing those sites of the plant which produce said auxin.

4. The process as defined in claim 3 wherein the removal of said sites of the plant which produce said auxin is accomplished by first pruning during a first year of plant growth and then periodically harvesting young vegetative tissues from the plant during a second and subsequent years of plant growth.

5. The process as defined in claim 4 wherein said pruning during said first year of plant growth further includes stem pruning four times during said first year of plant growth.

6. The process as defined in claim 5 wherein said stem pruning includes:
a first pruning after the last frost,
a second pruning about 12 to 20 weeks after said first pruning,
a third pruning about 8 to 12 weeks after said second pruning,
a fourth pruning after the last frost at the end of said first year of plant growth.

7. The process as defined in claim 6 further including root pruning during said second year of plant growth, said root pruning further including:
a first pruning of about ⅓ of the roots;
a second pruning of about ⅓ of the roots about five weeks after said first pruning of about ⅓ of the roots;
a third pruning of about ⅓ of the roots about five weeks after said second pruning of about ⅓ of the roots.

8. The process as defined in claim 6 wherein:
said first pruning includes heading back stems to less than about 50 cm. above the ground;
said second pruning includes heading back stems with a crotch angle less than about 30° from the main stem of the plant to about 50 cm. above the ground, heading back those stems between about 30° and about 70° from the main stem to the third bud from the stem tip;
said third pruning includes heading back stems with angles less than about 30° from the main stem to about 50 cm. above the ground, heading back the stems between about 30° and about 70° from the main stem to the third bud from the stem tip;
said fourth pruning includes heading back stems with angles between about 30° and about 70° from the main stem to the third bud from the stem tip.

9. The process as defined in claim 7 further including the step of pinching off about 10% to about 30% of the leaf area at the tip of the leaf of about 20% to about 60% of all the leaves on each stem at the same time as each of said root prunings during said first or subsequent years of plant growth.

10. The process as defined in claim 4 wherein said periodic harvesting of young vegetative tissues is accomplished at about two to four week intervals during said second and subsequent years of plant growth.

11. The process as defined in claim 10 wherein said periodic harvesting of young vegetative tissues is accomplished about 10 to 12 times per year of plant growth.

12. The process as defined in claim 4 wherein said young vegetative tissues are between about 3 to about 20 days old.

13. The process as defined in claim 12 wherein about 10% to about 30% of the leaf area at the tip of the leaf of about 20% to about 60% of all the leaves on each stem is pinched off at least about 6 to about 8 days before each harvest of young vegetative tissues.

14. A process for increasing the production of camptothecins by a plant comprising the step of:
increasing the formation of camptothecins-bearing trichomes on young vegetative tissues of the plant by physically, biologically, or ecologically controlling the amount of hormones produced by the plant.

15. The process as defined in claim 14 wherein said physical, biological, or ecological control of the amount of hormones produced by the plant includes reducing the amount of auxin produced by the plant.

16. The process as defined in claim 15 wherein the amount of said auxin produced by the plant is reduced by removing those sites of the plant which produce said auxin.

17. The process as defined in claim 16 wherein the removal of said sites of the plant which produce said auxin is accomplished by first pruning during a first year of plant growth and then periodically harvesting young vegetative tissues from the plant during a second and subsequent years of plant growth.

18. The process as defined in claim 17 wherein said pruning during said first year of plant growth further includes stem pruning four times during said first year of plant growth.

19. The process as defined in claim 18 wherein said stem pruning includes:
a first pruning after the last frost,
a second pruning about 12 to 20 weeks after said first pruning,
a third pruning about 8 to 12 weeks after said second pruning,
a fourth pruning after the last frost at the end of said first year of plant growth.

20. The process as defined in claim 19 further including root pruning during said second year of plant growth, said root pruning further including:
a first pruning of about ⅓ of the roots;
a second pruning of about ⅓ of the roots about five weeks after said first pruning of about ⅓ of the roots;
a third pruning of about ⅓ of the roots about five weeks after said second pruning of about ⅓ of the roots.

21. The process as defined in claim 19 wherein:
said first pruning includes heading back stems to less than about 50 cm. above the ground;
said second pruning includes heading back stems with a crotch angle less than 30° from the main stem of the plant to about 50 cm. above the ground, heading back those stems between about 30° and about 70° from the main stem to the third bud from the stem tip;
said third pruning includes heading back stems with angles less than 30° from the main stem to about 50 cm. above the ground, heading back the stems between about 30° and 70° from the main stem to the third bud from the stem tip;
said fourth pruning includes heading back stems with angles between about 30° and about 70° from the main stem to the third bud from the stem tip.

22. The process as defined in claim 20 further including the step of pinching off about 10% to about 30% of the leaf area at the tip of the leaf of about 20% to about 60% of all the leaves on each stem at the same time as each of said root prunings during said first or subsequent years of plant growth.

23. The process as defined in claim 17 wherein said periodic harvesting of young vegetative tissues is accomplished at about two to four week intervals during said second and subsequent years of plant growth.

24. The process as defined in claim 23 wherein said periodic harvesting of young vegetative tissues is accomplished about 10 to 12 times per year of plant growth.

25. The process as defined in claim 17 wherein said young vegetative tissues are between about 3 to about 20 days old.

26. The process as defined in claim 25 wherein about 10% to about 30% of the leaf area at the tip of the leaf of about 20% to about 60% of all the leaves on each stem is pinched off at least about 6 to about 8 days before each harvest of said young vegetative tissues.

27. A process for increasing the production of camptothecins by a plant comprising the steps of:
increasing the amount of young vegetative tissues produced by the plant;
increasing the formation of camptothecins-bearing trichomes on said increased amount of said young vegetative tissues by physically, biologically, or ecologically controlling the amount of hormones produced by the plant.

28. The process as defined in claim 27 wherein said physical, biological, or ecological control of the amount of hormones produced by the plant includes reducing the amount of auxin produced by the plant.

29. The process as defined in claim 28 wherein the amount of said auxin produced by the plant is reduced by removing those sites of the plant which produce said auxin.

30. The process as defined in claim 29 wherein both the removal of those sites of the plant which produce auxin and increasing the amount of young vegetative tissues produced by the plant is accomplished by first pruning during a first year of plant growth and then periodically harvesting young vegetative tissues from the plant during a second and subsequent years of plant growth.

31. The process as defined in claim 30 wherein said pruning during said first year of plant growth further includes stem pruning four times during said first year of plant growth.

32. The process as defined in claim 31 wherein said stem pruning includes:
a first pruning after the last frost,
a second pruning about 12 to 20 weeks after said first pruning,
a third pruning about 8 to 12 weeks after said second pruning,
a fourth pruning after the last frost at the end of said first year of plant growth.

33. The process as defined in claim 32 further including root pruning during said second year of plant growth, said root pruning further including:
a first pruning of about ⅓ of the roots;
a second pruning of about ⅓ of the roots about five weeks after said first pruning of about ⅓ of the roots;
a third pruning of about ⅓ of the roots about five weeks after said second pruning of about ⅓ of the roots.

34. The process as defined in claim 32 wherein:
said first pruning includes heading back stems to less than about 50 cm. above the ground;
said second pruning includes heading back stems with a crotch angle less than 30° from the main stem of the plant to about 50 cm. above the ground, heading back those stems between about 30° and about 70° from the main stem to the third bud from the stem tip;
said third pruning includes heading back stems with angles less than about 30° from the main stem to about 50 cm. above the ground, heading back the stems between about 30° and about 70° from the main stem to the third bud from the stem tip;
said fourth pruning includes heading back stems with angles between about 30° and about 70° from the main stem to the third bud from the stem tip.

35. The process as defined in claim 33 further including the step of pinching off about 10% to about 30% of the leaf area at the tip of the leaf of about 20% to about 60% of all the leaves on each stem at the same time as each of said root prunings during said first or subsequent years of plant growth.

36. The process as defined in claim 30 wherein said periodic harvesting of said young vegetative tissues is accomplished at about two to four week intervals during said second and subsequent years of plant growth.

37. The process as defined in claim 36 wherein said periodic harvesting of said young vegetative tissues is accomplished about 10 to 12 times per year of plant growth.

38. The process as defined in claim 30 wherein said young vegetative tissues are between about 3 to about 20 days old.

39. The process as defined in claim 38 wherein about 10% to about 30% of the leaf area at the tip of the leaf of about 20% to about 60% of all the leaves on each stem is pinched off at least about 6 to about 8 days before each harvest of said young vegetative tissues.

40. A process for increasing the amount of camptothecins-bearing trichomes harvested from a plant comprising the steps of:
increasing the amount of young vegetative tissues produced by the plant;
increasing the formation of camptothecins-bearing trichomes on said increased amount of young vegetative tissues;
reducing the amount of camptothecins-bearing trichomes falling away from said young vegetative tissues after the harvesting of the young vegetative tissues.

41. The process as defined in claim 40 wherein said amount of camptothecins-bearing trichomes falling away from said young vegetative tissues is reduced by processing said young vegetative tissues within about two days after harvesting.

42. The process as defined in claim 40 wherein the amount of said camptothecins-bearing trichomes falling away from said young vegetative tissues is reduced by extracting freshly harvested matters said young vegetative tissues shortly after harvesting.

43. A process for increasing the amount of camptothecins harvested from a plant which includes camptothecins-bearing trichomes comprising the steps of:
increasing the amount of young vegetative tissues produced by the plant;
increasing the formation of camptothecins-bearing trichomes on said increased amount of young vegetative tissues;
reducing the number of camptothecins-bearing trichomes falling away from the young vegetative tissues after the harvesting of the young vegetative tissues;
breaking said trichome walls to release the camptothecins with the camptothecins-bearing trichomes.

44. The process as defined in claim 43 wherein said trichome walls are broken using ultrasound.

45. The process as defined in claim 43 wherein said trichome walls are broken using a homogenizer.

46. The process as defined in claim 43 wherein said trichome walls are broken by a physical impact on said trichome walls.

47. The process as defined in claim 43 wherein said camptothecins are collected in a solvent.
